(19) United States
(12) Patent Application Publication
(10) Pub. No.: US 2011/0314051 A1
(43) Pub. Date: Dec. 22, 2011

(54) SUPPLEMENTAL MEDIA DELIVERY

(75) Inventors: Rene Cavet, Darmstadt (DE); Joshua S. Cohen, Frankfurt (DE)

(73) Assignee: iPharro Media GmbH

(21) Appl. No.: 13/069,185

(22) Filed: Mar. 22, 2011

Related U.S. Application Data
(63) Continuation of application No. 12/851,329, filed on Aug. 5, 2010, now abandoned.
(60) Provisional application No. 61/231,546, filed on Aug. 5, 2009.

(51) Int. Cl. G06F 17/30

(52) U.S. Cl. 707/769; 707/E17.014

(57) ABSTRACT

In some examples, the technology identifies a media and provide a consumer with an option to click on a link associated with the media with a remote control to direct the video stream directly to a website sponsored by the commercial entity associated with the media. In other examples, the technology identifies a media displayed on a subscriber's first computing device and displays the same media and/or a related media on the subscriber's second computing device.

### CROSS-REFERENCE TO RELATED APPLICATIONS

This application claims the benefit under 35 U.S.C. §119(e) of U.S. Provisional Patent Application No. 61/231,546, filed Aug. 5, 2009, which is incorporated herein by reference in its entirety.

### BACKGROUND

The present disclosure relates to supplemental media delivery, utilizing, for example, media analysis and retrieval. In particular, in some examples, the present disclosure relates to linking media content to websites and/or other media content based on a media feature detection, identification, and classification system. In other examples, the present disclosure relates to delivering media content to a second subscriber computing device based on a media feature detection, identification, and classification system.

The availability of broadband communication channels to end-user devices combined with a proliferation of user media access devices has enabled ubiquitous media coverage with image, audio, and video content. The increasing amount of media content that is transmitted globally has boosted the need for intelligent content management. Providers must organize their content and be able to analyze their content. Similarly, broadcasters and market researchers want to know when and where specific footage has been broadcast. Content monitoring, market trend analysis, copyright protection, and asset management is challenging, if not impossible, due to the increasing amount of media content. However, a need exists to selectively supplement media delivery, for example, to improve advertising campaigns in this technology field.

### SUMMARY

Other aspects and advantages of the present disclosure will become apparent from the following detailed description, taken in conjunction with the accompanying drawings, illustrating the principles of the disclosure by way of example only.

The following presents a simplified summary in order to provide a basic understanding of some aspects of the claimed subject matter. This summary is not an extensive overview, and is not intended to identify key/critical elements or to delineate the scope of the claimed subject matter. Its sole purpose is to present some concepts in simplified form as a prelude to the more detailed description that is presented later.

Methods, systems, and program products are provided to facilitate supplemental media delivery. In one example, a method may include generating a first descriptor based on first media data, such as an advertisement video. The first media data may be associated with a first subscriber computing device, such as a set top box (e.g., cable box, satellite receiver box, etc.). The method may further include comparing the first descriptor with a second descriptor and determining second media data based on the comparison. The method may further include transmitting the second media data to a second subscriber computing device, such as a personal computer.

To the accomplishment of the foregoing and related ends, certain illustrative aspects are described herein in connection with the following description and the annexed drawings. These aspects are indicative, however, of but a few of the various ways in which the principles of the claimed subject matter may be employed and the claimed subject matter is intended to include all such aspects and their equivalents. Other advantages and novel features may become apparent from the following detailed description when considered in conjunction with the drawings.

### BRIEF DESCRIPTION OF THE DRAWINGS

The foregoing and other objects, features, and advantages of the present disclosure, as well as the disclosure itself, will be more fully understood from the following description of various embodiments, when read together with the accompanying drawings.

FIG. 1 shows a system block diagram of an exemplary system for managing an advertisement campaign;

FIG. 2 is a block diagram of an exemplary campaign advertising system;

FIG. 3 is a block diagram of another exemplary campaign advertising system;

FIGS. 4A-4C illustrate exemplary subscriber computing devices;

FIG. 5 shows a display of exemplary records of detected ads;

FIGS. 6A-6D illustrate exemplary subscriber computing devices;

FIG. 7 is a block diagram of an exemplary content analysis server;

FIG. 8 is a block diagram of an exemplary subscriber computing device;

FIG. 9 illustrates an exemplary flow diagram of a generation of a digital video fingerprint;

FIG. 10 shows an exemplary flow diagram for managing an advertisement campaign;

FIG. 11 shows another exemplary flow diagram for managing an advertisement campaign;

FIG. 12 shows another exemplary flow diagram for supplemental media delivery;

FIG. 13 shows another exemplary flow diagram for supplemental media delivery;

FIG. 14 shows another exemplary flow diagram for supplemental media delivery;

FIG. 15 is another exemplary system block diagram for managing an advertisement campaign;

FIG. 16 illustrates a block diagram of an exemplary multi-channel video monitoring system;

FIG. 17 illustrates a screen shot of an exemplary graphical user interface (GUI);

FIG. 18 illustrates an example of a change in a digital image representation subframe;

FIG. 19 illustrates an exemplary flow chart for the digital video image detection system;

FIG. 20A illustrates an exemplary traversed set of K-NN nested, disjoint feature subspaces in feature space; and

FIG. 20B illustrates the exemplary traversed set of K-NN nested, disjoint feature subspaces with a change in a queried image subframe.

### DETAILED DESCRIPTION

It should be appreciated that the particular implementations shown and described herein are examples of the technology and are not intended to otherwise limit the scope of the technology in any way. Further, the techniques are suitable for applications in teleconferencing, robotics vision, unmanned vehicles, and/or any other similar applications.

As a general overview of some exemplary embodiments of the disclosure, in some examples, when a user is using two or more computing devices (e.g., a media access device, a computer and a television, a mobile phone and a television, etc.) to access media (e.g., website on the computer and television show on the television, movie on the mobile phone and television show on the television), the technology enables delivery of related media between the computing devices to enhance the user's experience. In other words, if the user is viewing an advertisement about cooking on the user's television, the technology can deliver an advertisement about a local grocery store to the user's computer (e.g., a pop-up on the user's display device, direct a web browser to the local grocery store's website, etc.) that may also appeal to the user's taste.

The technology may identify the media that the user is accessing by generating an indicator, such as a signature or fingerprint, of the media and comparing the fingerprint with one or more stored fingerprints (for example, identify that the user is viewing a television show, identify that that user is viewing an advertisement, identify that the user is surfing a vehicle dealership's website, etc.). Based on the identification of the media that the user is viewing and/or accessing on one of the computing devices, the technology may determine related media (e.g., based on a pre-defined association of the media, based on a dynamically generated association, based on a content type, based on localization parameters, etc.) and transmit the related media to the other computing device for viewing by the user.

For example, if the user is watching a cooking show on the user's television, the technology may transmit a local grocery store advertisement to the user's computer for viewing by the user. As another example, if the user is viewing a national advertisement for a grocery store on the user's television, the technology transmits a local advertisement for the grocery store to the user's mobile phone for viewing by the user. As a further example, if the user is watching a grocery store advertisement on the user's mobile phone, the technology may transmit the same grocery store advertisement to the user's computer for viewing by the user. The technology may determine the identity of the original media by generating a fingerprint at the user's computing device and/or at a centralized location thereby identifying the media without requiring a separate data stream that includes the identification.

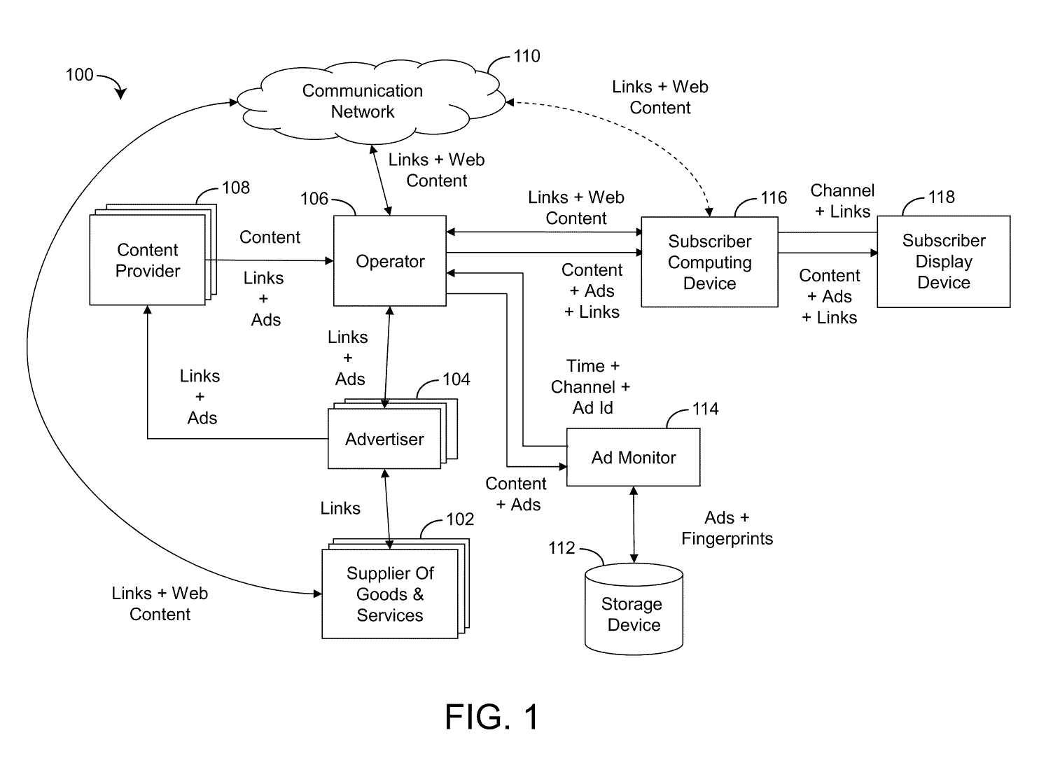

FIG. 1 shows a system block diagram of an exemplary system 100 for managing an advertisement campaign. A supplier 102 of one or more of goods and services may retain one or more advertisers 104 to develop an ad campaign to promote such goods and or services to consumers to promote sales leading to larger profits. Advertisers have often relied upon mass media to convey their persuasive messages to large audiences. In particular, advertisers often rely on broadcast media, by placing advertisements, such as commercial messages, within broadcast programming.

An operator 106 (e.g., cable network operator, satellite television operator, internet protocol television (IPTV) operator, multimedia streaming operator, etc.) receives broadcast content from one or more content providers 108. The operator 106 makes the content available to an audience in the form of medial broadcast programming, such as television programming. The operator 106 can be a local, regional, or national television network, or a carrier, such as a satellite dish network, cable service provider, a telephone network provider, or a fiber optic network provider. For situations in which members of the audience purchase such broadcast services, such as cable and satellite dish networks, members of the audience can be referred to as subscribers. The advertisers 104 provide advertising messages to the one or more content providers 108 and/or to the operator 106. The one or more content providers 108 and/or the operator 106 intersperse such advertising messages with content to form a combined signal including content and advertising messages. Such signals can be provided in the form of channels, allowing a single operator to provide to subscribers more than one channel of such content and advertising messages.

For network-enabled subscriber terminals, the operator 106 may provide one or more links to additional information available to the subscriber over a network 110, such as the Internet. These links may direct subscribers to networked information related to a supplier of goods and/or services, such as the supplier's web page. Alternatively or in addition, such links may direct subscribers to networked information related to a different supplier, such as a competitor. Alternatively or in addition, such links may direct subscribers to networked information related to other information, such as information related to the content, surveys, and more generally, any information that one may choose to make available to subscribers. Such links may be displayed to subscribers in the form of click-through icons. For Worldwide Web applications, the links may include a Uniform Resource Locator (URL) of a hypertext markup language (HTML) Web page, to which a supplier of goods or services chooses to direct subscribers.

Subscribers generally have some form of a subscriber display device 118 or terminal through which they view broadcast media. The subscriber display device 118 may be in the form of a television receiver, a simple display device, a mobile display device, a mobile video player, or a computer terminal. In at least some embodiments, the subscriber display device 118 receives such broadcast media through a subscriber computing device 116 (e.g., a set top box, a personal computer, a mobile phone, etc.). The subscriber computing device 116 can include a receiver configured to receive broadcast media through a service provider. For example, the set top box can include a cable box and/or a satellite receiver box. The subscriber computing device 116 can generally be within control of the subscriber and usable to receive the broadcast media, to select from among multiple channels of broadcast media, when available, and/or to provide any sort of unscrambling that may be required to allow a subscriber to view one or more channels.

In some embodiments, one or more of the subscriber computing device 116 and the subscriber display device 118 are configured to provide displayable links to the subscriber. The subscriber, in turn, may select one or more links displayed at the display device 118 to view or otherwise access the linked information. To select the links, one or more of the subscriber computing device 116 and the subscriber display device 118 provide the user with a cursor, pointer, or other suitable means to allow for selection and click-through.

In the exemplary embodiment, an operator 106 receives content from one or more content providers 108. An advertiser 104 receives one or more links from a supplier 104 of goods and services. The operator 106 also receives the one or more links from the advertiser 104. The advertiser 104 may also provide to the one or more content providers 108 or to the operator 106, or to both, one or more commercial messages to be included within the broadcast media. The one or more content providers 108 or the operator 106, or both, combine the content (broadcast programming) with the one or more advertisements into a media broadcast. The operator 106 also provides the one or more links to the subscriber computing device 116/subscriber display device 118 in a suitable manner to allow the subscriber computing device 116/subscriber display device 118 to display to subscribers the one or links associated with a respective advertisement within a media broadcast channel being viewed by the subscriber. Such combination may be in the form of a composite broadcast signal, in which the links are embedded together with the content and advertisements, a sideband signal associated with the broadcast signal, or any other suitable approach for providing subscribers with an Internet television (TV) service.

An advertisement monitor 114 can receive the same media broadcast of content and advertisements embedded therein. From the received broadcast media, the ad monitor 114 identifies one or more target ads. Exemplary systems and methods for accomplishing such detection are described further below. In some embodiments, the ad monitor 114 receives a sample of a target ad beforehand, and stores the ad itself, or some processed representation of the ad in an accessible manner. For example, the ad and/or processed representation of the ad may be stored in a database (e.g., stored in storage device 112) accessible by the ad monitor 114. Thus, the ad monitor 114 receives the media broadcast of content and ads, identifying any target ads by comparison with a previously stored ad and/or a processed version of the target ad. The ad monitor 114 generates an indication to the operator 106 that the target ad was included in the media broadcast. In some embodiments, the ad monitor 114 generates a record of such an occurrence of the target ad that may include the associated channel, the associated time, and an indication of the target ad.

Preferably, such an indication is provided to the operator 106 in real time, or at least near real time. The latency between detection of the target ad and provision of the indication of the ad is preferably less than the time of the target advertisement. Thus, for a typical 30 or 60 second advertisement, the latency is less than about 5 seconds.

The operator 106, in turn, includes within the media broadcast, or otherwise provides to subscribers therewith, one or more preferred links associated with the target ad. The operator 106 may implement business rules that include one or more links that have been pre-associated with the target advertisement.

In some embodiments, the operator 106 maintains a record of an association of preferred link(s) to each target advertisement. These links may be provide by the advertiser 104, a competitor, the operator 106, or virtually anyone else interested in providing links related to the target advertisement. Such an association may be updated or otherwise modified by the operator 106. Any contribution to latency between media broadcast of the target advertisement and display of the associated links is preferably much less than the duration of the target advertisement. Preferably, any additional latency is small enough to preserve the overall latency to not more than about 5 or 10 seconds.

Preferably, the ad monitor 114 is capable of identifying any one of multiple advertisements within a prescribed latency period. Each of the multiple target ads may be associated with a different respective supplier of goods and/or services. Alternatively or in addition, each of the multiple target ads may be associated with a different advertiser. Alternatively or in addition, each of the multiple target ads may be associated with a different operator. Thus, the ad monitor 114 may monitor more than one media broadcast channels, from one or more operators, searching for and identifying for each, occurrences of one or more advertisements associated with one or more suppliers of goods and/or services.

In some embodiments, the ad monitor 114 maintains a record of the channels, display times of occurrences of a target advertisement. When tracking more than one target advertisement, the ad monitor 114 may maintain such a record in a tabular form.

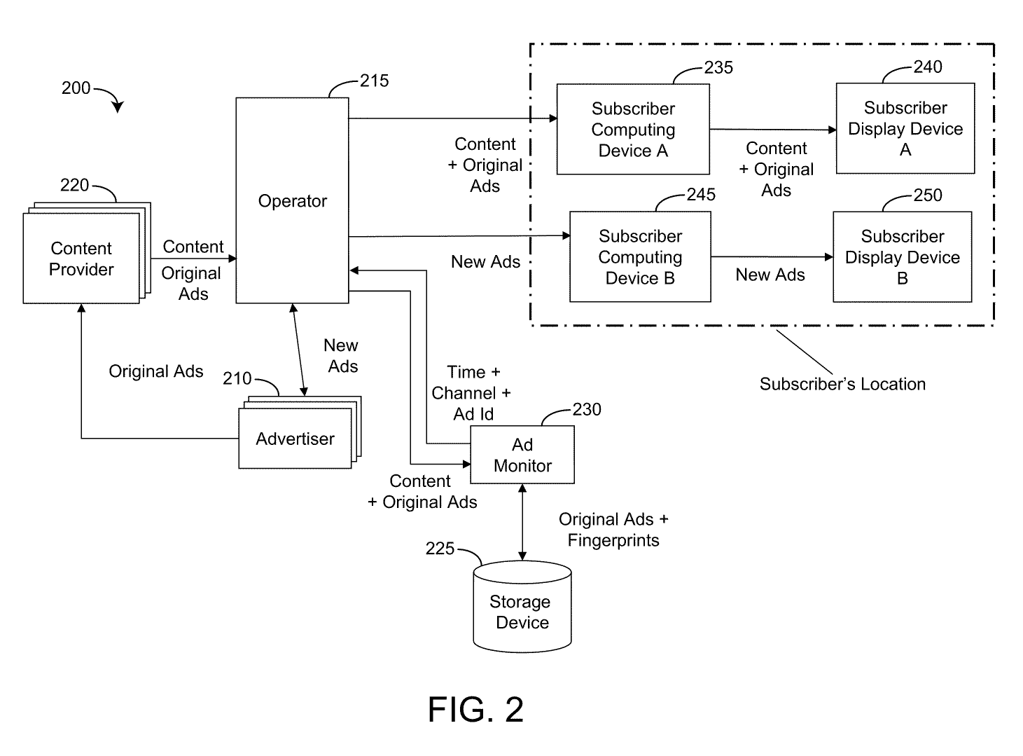

FIG. 2 is a block diagram of an exemplary system 200, such as an advertising campaign system or a supplemental media system. Although the systems described herein are referred to as advertising campaign systems or supplemental media systems, the systems utilized by the technology can manage and/or delivery any type of media, such as advertisements, movies, television shows, trailers, etc.

The system 200 includes a content provider 220 (e.g., a media storage server, a broadcast network server, a satellite provider, etc.), an operator 215 (e.g., a telephone network operator, an IPTV operator, a fiber optic network operator, a cable television network operator, etc.), an advertiser 210, an ad monitor 230 (e.g., a content analysis server, a content analysis service, etc.), a storage device 225, subscriber computing devices A (reference numeral 235) and B (reference numeral 245) (e.g., a set top box, a personal computer, a mobile phone, a laptop, a television with integrated computing functionality, etc.), and subscriber display devices A (reference numeral 240) and B (reference numeral 250) (e.g., a television, a computer monitor, a video screen, etc.). The content provider 220, the operator 215, the advertiser 210, and the ad monitor 230 can, for example, implement any of the functionality and/or techniques as described herein.

The advertiser 210 transmits one or more original ads to the content provider 220 (e.g., a car advertisement for display during a car race, a health food advertisement for display during a cooking show, etc.). The content provider 220 transmits content (e.g., television show, movie, etc.) and/or the original ads (e.g., picture, video, etc.) to the operator 215.

The operator 215 transmits the content and the original ads to the ad monitor 230. The ad monitor 230 generates a descriptor for each original ad and compares the descriptor with one or more descriptors stored in the storage device 225 to identify ad information (in this example, time, channel, and ad id). The ad monitor 230 transmits the ad information to the operator 215. The operator 215 requests the same ads and/or relevant ads from the advertiser 210 based on the ad information. The advertiser 210 determines one or more new ads based on the ad information (e.g., associates ads together based on subject, associates ads together based on information associated with the supplier of goods and services, etc.) and transmits the one or more new ads to the operator 215.

The operator 215 transmits the content and the original ads to the subscriber computing device A 235 for display on the subscriber display device A 240. The operator 215 transmits the new ads to the subscriber computing device B 245 for display on the subscriber display device B 250.

In some examples, the subscriber computing device A 235 generates a descriptor for an original ad and transmits the descriptor to the ad monitor 230. In other examples, the subscriber computing device A 235 requests the determination of the one or more new ads and transmits the new ads to the subscriber computing device B 245 for display on the subscriber display device B 250.

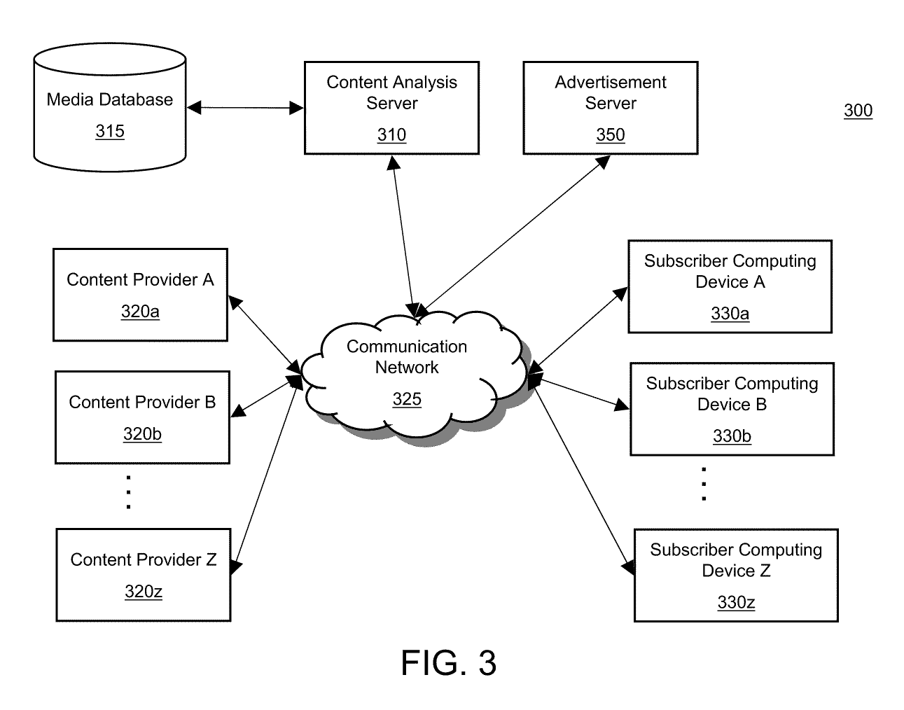

FIG. 3 is a block diagram of another exemplary campaign advertising system 300. The system 300 includes one or more content providers A 320a, B 320b through Z 320z (hereinafter referred to as content providers 320), a content analyzer, such as a content analysis server 310, a communications network 325, a media database 315, one or more subscriber computing devices A 330a, B 330b through Z 330z (hereinafter referred to as subscriber computing device 330), and a advertisement server 350. The devices, databases, and/or servers communicate with each other via the communication network 325 and/or via connections between the devices, databases, and/or servers (e.g., direct connection, indirect connection, etc.).

The content analysis server 310 can identify one or more frame sequences for the media stream. The content analysis server 310 can generate a descriptor for each of the one or more frame sequences in the media stream and/or can generate a descriptor for the media stream. The content analysis server 310 compares the descriptors of one or more frame sequences of the media stream with one or more stored descriptors associated with other media. The content analysis server 310 determines media information associated with the frame sequences and/or the media stream.

In some examples, the content analysis server 310 can generate a descriptor based on the media data (e.g., unique fingerprint of media data, unique fingerprint of part of media data, etc.). The content analysis server 310 can store the media data, and/or the descriptor via a storage device (not shown) and/or the media database 315.

In other examples, the content analysis server 310 generates a descriptor for each frame in each multimedia stream. The content analysis server 310 can generate the descriptor for each frame sequence (e.g., group of frames, direct sequence of frames, indirect sequence of frames, etc.) for each multimedia stream based on the descriptor from each frame in the frame sequence and/or any other information associated with the frame sequence (e.g., video content, audio content, metadata, etc.).

In some examples, the content analysis server 310 generates the frame sequences for each multimedia stream based on information about each frame (e.g., video content, audio content, metadata, fingerprint, etc.).

Although FIG. 3 illustrates the subscriber computing device 330 and the content analysis server 310 as separate, part or all of the functionality and/or components of the subscriber computing device 330 and/or the content analysis server 310 can be integrated into a single device/server (e.g., communicate via intra-process controls, different software modules on the same device/server, different hardware components on the same device/server, etc.) and/or distributed among a plurality of devices/servers (e.g., a plurality of backend processing servers, a plurality of storage devices, etc.). For example, the subscriber computing device 330 can generate descriptors. As another example, the content analysis server 310 includes an user interface (e.g., web-based interface, stand-alone application, etc.) which enables a user to communicate media to the content analysis server 310 for management of the advertisements.

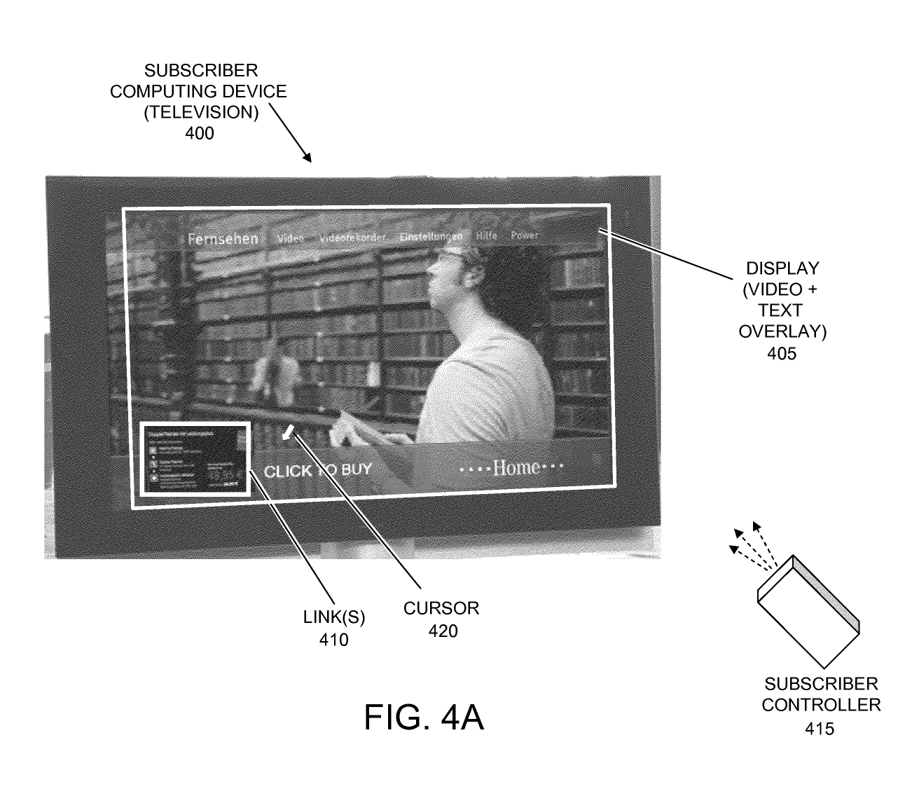

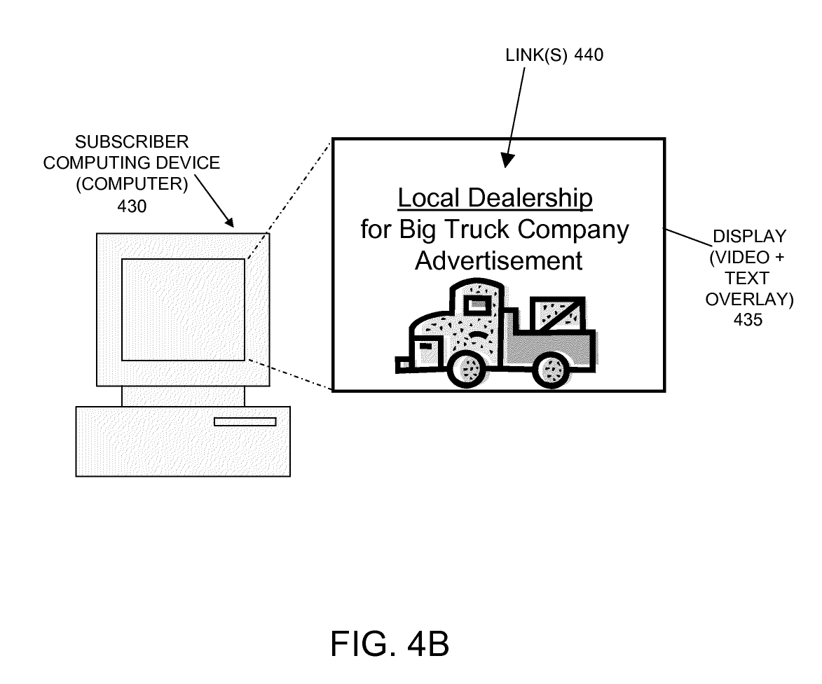

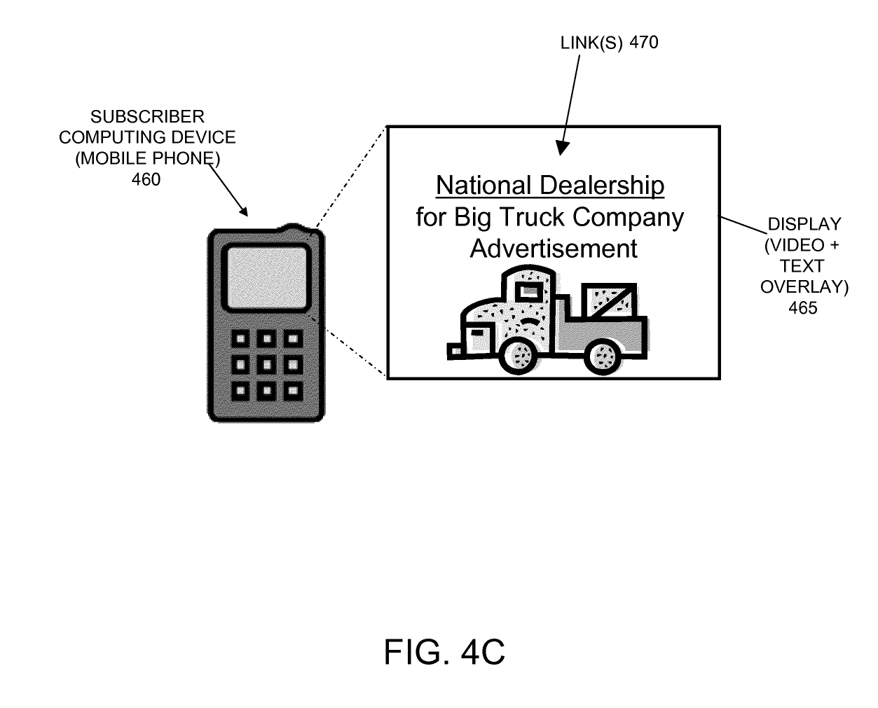

FIGS. 4A-4C illustrate exemplary subscriber computing devices 400, 430, and 460. Each subscriber computing device (e.g., television 400, computer 430, and mobile phone 460) includes a subscriber display (e.g., displays 405, 435, and/or 465). Preferably, the display is configured to display video content of the media broadcast together with indicia of the one or more associated links (e.g., links 410, 440, and/or 470). For displayed advertisements, the one or more links are preferably those links that have been previously associated with the displayed advertisement. The display may also include a cursor 420 or other suitable pointing device. The cursor/pointer is preferably controllable from a subscriber remote controller 415, such that the subscriber can select (e.g., click on) a displayed indicia of a preferred one of the one or more links. In some embodiments, the links may be displayed separately, such as on a separate computer monitor, while the media broadcast is displayed on the subscriber display device as shown.

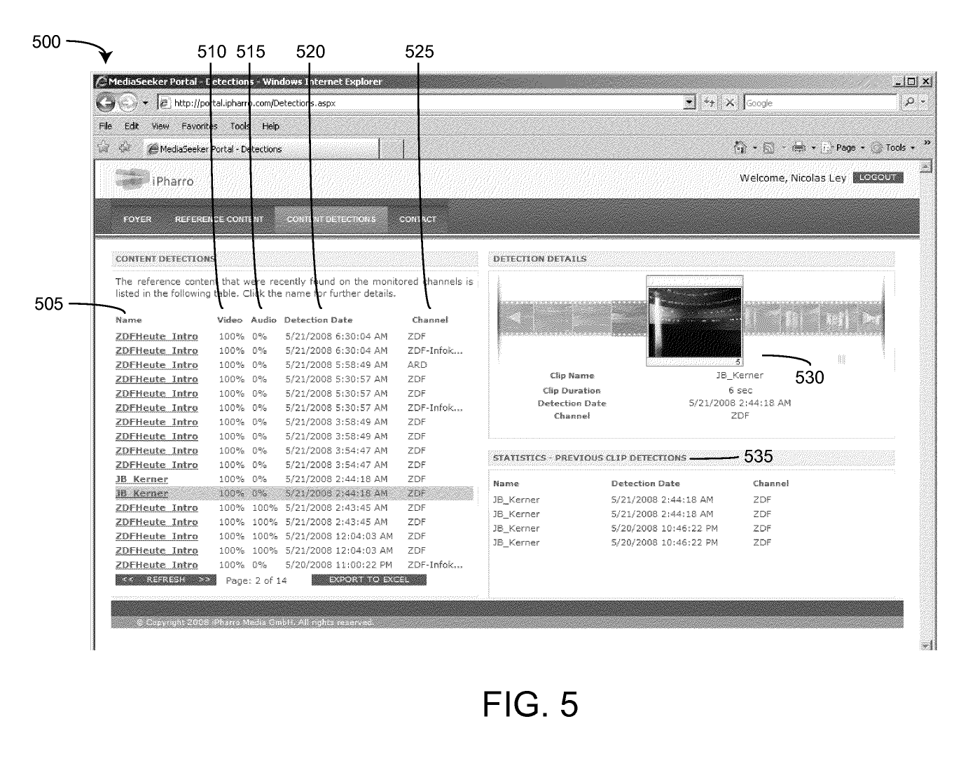

FIG. 5 shows a display 500 of exemplary records of detected ads as may be identified and generated by an ad monitor (FIG. 1). Such a display 500 may be observed at an ad tracking administration console. The exemplary console display 500 includes a list of target ads. The list may include names for each target ad (shown in names column 505). The list may also include a confidence value associated with detection of the respective target ad. Separate confidence values may be included for each of video (shown in video confidence column 510) and audio (shown in audio confidence column 515). Also included are date and time of detection of the target ad (shown in detection date column 520), as well as the particular channel, and or operator, upon which the ad was detected (shown in channel column 525).

In some embodiments, the ad monitor console may display detection details (shown in detection details section 530), such as a recording of the actual detected ad, for later review and/or comparison. Alternatively or in addition, the ad monitor may generate statistics associated with the target advertisement (shown in statistics section 535). Such statistics may include total number of occurrences and/or periodicity of occurrences of the target ad. Such statistics may be tracked on a per channel basis, a per operator basis, or some combination of per channel and per operator.

In some embodiments, the system and methods described herein can provide flexibility to an advertiser to execute an ad campaign that includes time sensitive features. For example, subscribers can be presented with one or more links associated with a target ad as a function of one or more of the time of the ad, the channel through which the ad was observed, and a geographic location or region of the subscriber. For example, as part of an advertising strategy to promote greater interest in the target ad, time sensitive links are associated with the target ad.

These links may include links to promotional information that may include coupons or other incentives to those subscribers that respond to the associated link (e.g., click through) within a given time window. Such time windows may be during and immediately following a displayed ad for a predetermined period. Such strategies may be similar to media broadcast ads that offer similar incentives to subscribers who call into a telephone number provided during the ad. In some embodiments, the linked information may direct a subscriber to an interactive session with an ad representative. Providing the ability to selectively provide associated links based on channel, geography, or other such limitations, allows an advertiser to balance resources according to the number subscribers likely to click-through to the linked information. A more detailed description of embodiments of systems and processes for video fingerprint detection are described in more detail below.

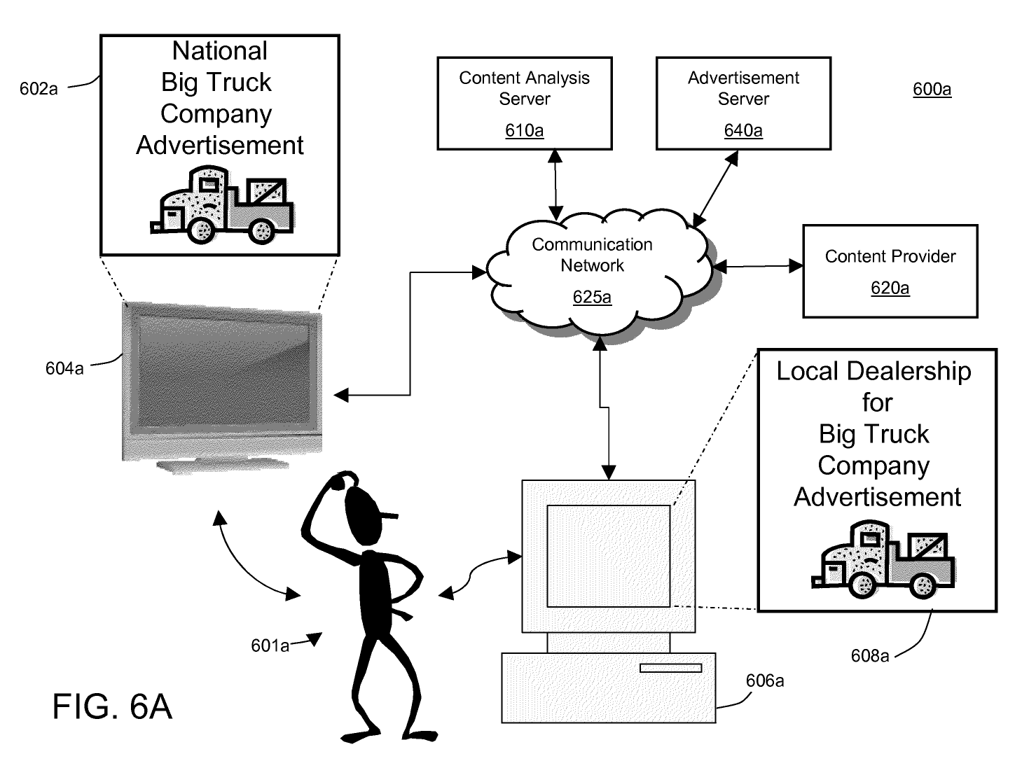

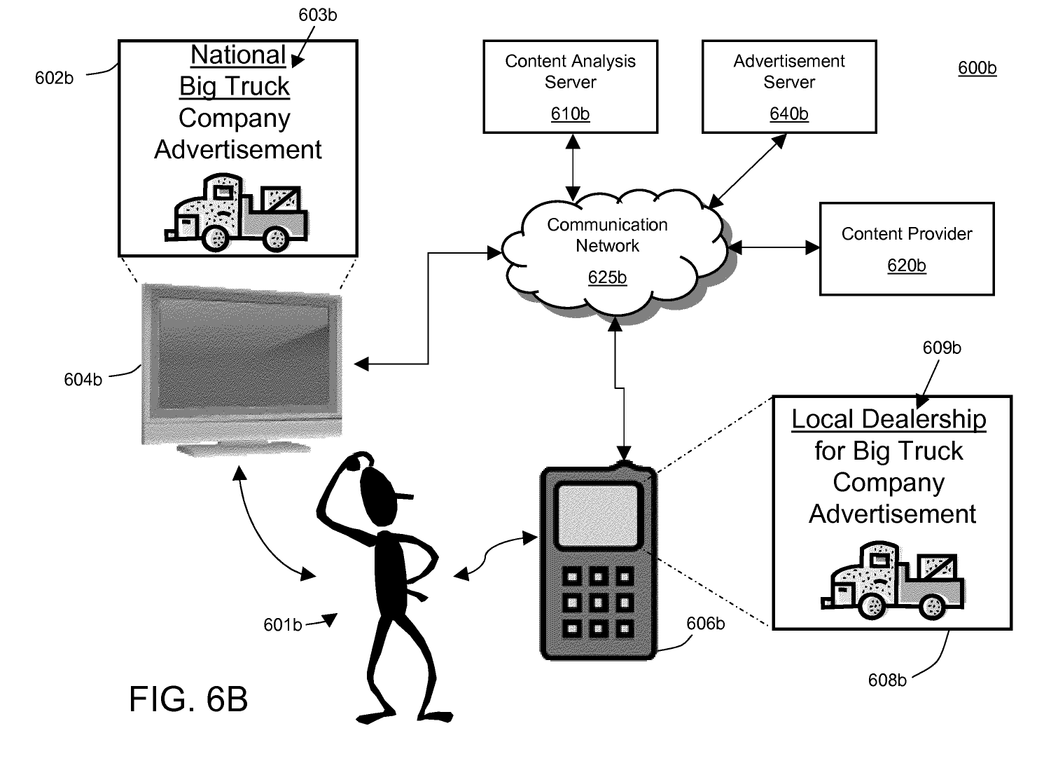

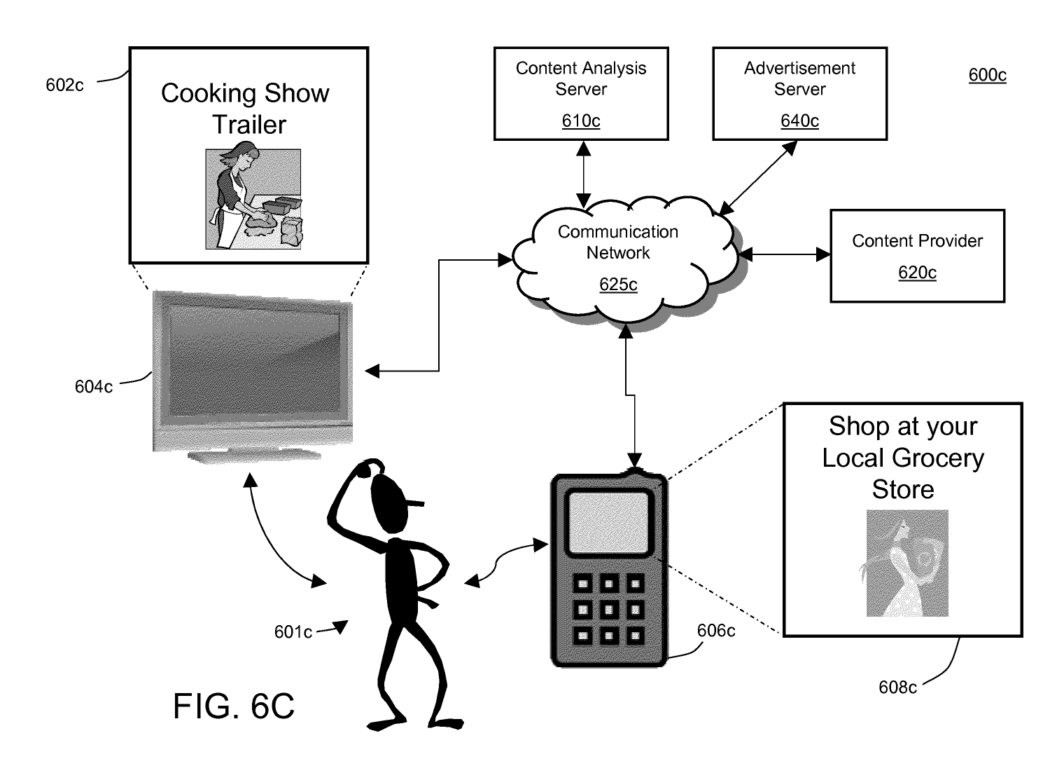

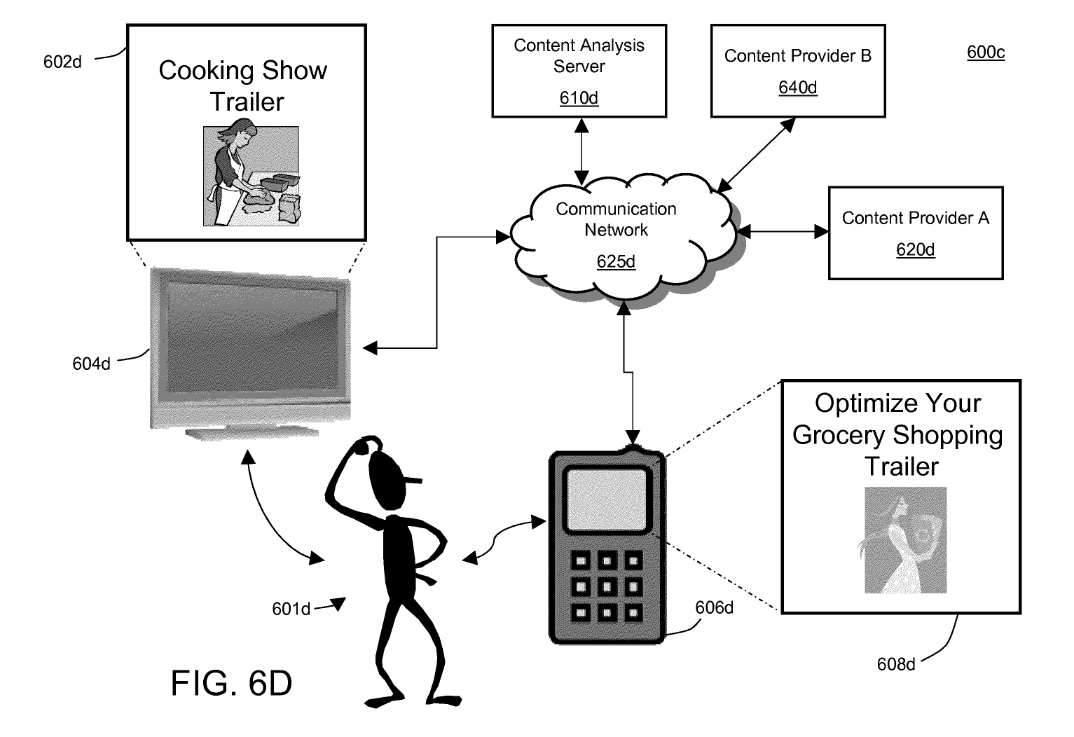

FIG. 6A illustrate exemplary subscriber computing devices 604a and 608a utilizing an advertisement management system 600a. The system 600a includes the subscriber computing device 604a, the subscriber computing device 608a, a communication network 625a, a content analysis server 610a, an advertisement server 640a, and a content provider 620a. A user 601a utilizes the subscriber computing devices 604a and 606a to access and/or view media (e.g., a television show, a movie, an advertisement, a website, etc.). As illustrated in screenshot 602a of the subscriber computing device 604a, the subscriber computing device 604a displays a national advertisement for trucks supplied by the content provider 620a. The content analysis server 610a analyzes the national advertisement to determine advertisement information and transmits the advertisement information to the advertisement server 640a.

The advertisement server 640a determines supplemental media, such as a local advertisement, based on the advertisement information and transmits the local advertisement to the subscriber computing device 606a. The subscriber computing device 606a displays the local advertisement as illustrated in screenshot 608a.

In some examples, the analysis of the national advertisement by the content analysis server 610a includes generating a descriptor for the national advertisement (in this example, ABD324297) and searching a plurality of descriptors to determine advertisement information associated with the national advertisement. For example, the content analysis server 610a searches a list of descriptors of advertisements to determine that the national advertisement is the national advertisement for Big Truck Company (in this example, ad id=BTCNA). As a further example, the content analysis server 610a transmits the ad id to the advertisement server 640a and the advertisement server 640a determines an advertisement based on the ad id (in this example, ad id=BTCNA). In this example, the advertisement server 640a determines that a local advertisement should be displayed on the subscriber computing device 606a (in this example, the local advertisement is associated with the ad id=BTCNA and the subscriber's geographic location) and identifies a local advertisement associated with the national advertisement for Big Truck Company (in this example, local advertisement for the Local Dealership of the Big Truck Company).

In some examples, the advertisement server 640a receives supplemental information, such as location information (e.g., global positioning satellite (GPS) location, street address for the subscriber, etc.), from the subscriber computing device 604a, the content analysis server 610a, and/or the content provider 620a to determine supplemental data, such as the location of the subscriber, for the local advertisement.

Although FIG. 6A depicts the subscriber computing devices displaying the national advertisement and the local advertisement, the content analysis server 610a can analyze any type of media (e.g., television, streaming media, movie, audio, radio, etc.) and transmit identification information to the advertisement server 640a. The advertisement server 640a can determine any type of media for display on the second subscriber device 606a. For example, the first subscriber device 604a displays a television show (e.g., cooking show, football game, etc.) and the advertisement server 640a transmits an advertisement (e.g., local grocery store, local sports bar, etc.) associated with the television show for display on the second subscriber device 606a.

Table 1 illustrates exemplary associations between the first media identification information and the second media.

TABLE 1
Exemplary Associations between Media

| | Subscriber | |
|---|---|---|
| First Media Identification | Location | Associated Second Media |
| Big Truck National Ad | Boston | Local Boston Big Truck |
| | | Regional Ad |
| Big Truck National Ad | New York | Local New York Big |
| | | Truck Regional Ad |
| Big Truck National Ad | Florida | Local Florida Big Truck |
| | | Regional Ad |
| Big Truck National Ad | NA | Big Truck National Ad |
| Quick Cooking Show | Atlanta | Local Atlanta Grocery Store |
| Little Truck National Ad | NA | Little Truck National Ad |
| Best Science Fiction Movie | United States | Advertisement for Science |
| | | Fiction Convention |

FIG. 6B illustrate exemplary subscriber computing devices 604b and 608b utilizing an advertisement management system 600b. The system 600b includes the subscriber computing device 604b, the subscriber computing device 608b, a communication network 625b, a content analysis server 610b, an advertisement server 640b, and a content provider 620b. A user 601b utilizes the subscriber computing devices 604b and 606b to access and/or view media (e.g., a television show, a movie, an advertisement, a website, etc.). As illustrated in screenshot 602b of the subscriber computing device 604b, the subscriber computing device 604b displays a national advertisement for trucks supplied by the content provider 620b and a link 603b supplied by the content analysis server 610b (in this example, the link 603b is a uniform resource locator (URL) to the website of the Big Truck Company). The link 603b is determined utilizing any of the techniques as described herein. The content analysis server 610b analyzes the national advertisement to determine advertisement information and transmits the advertisement information to the advertisement server 640b.

The advertisement server 640b determines a local advertisement based on the advertisement information and transmits the local advertisement to the subscriber computing device 606b. A link 609b is supplied by the content analysis server 610b (in this example, the link 609b is a URL to the website of the local dealership of the Big Truck Company). The subscriber computing device 606b displays the local advertisement and the link 609b as illustrated in screenshot 608b. The link 609b is determined utilizing any of the techniques as described herein.

FIG. 6C illustrate exemplary subscriber computing devices 604c and 608c utilizing an advertisement management system 600c. The system 600c includes the subscriber computing device 604c, the subscriber computing device 608c, a communication network 625c, a content analysis server 610c, an advertisement server 640c, and a content provider 620c. A user 601c utilizes the subscriber computing devices 604c and 606c to access and/or view media (e.g., a television show, a movie, an advertisement, a website, etc.). As illustrated in screenshot 602c of the subscriber computing device 604c, the subscriber computing device 604c displays a cooking show trailer supplied by the content provider 620c. The content analysis server 610c analyzes the cooking show trailer to determine information (in this example, trailer id=CookTrailerAB342) and transmits the information to the advertisement server 640c.

The advertisement server 640c determines a local advertisement based on the information (in this example, a direct relationship between the cooking show trailer and location information of the subscriber to the local advertisement) and transmits the local advertisement to the subscriber computing device 606c. The subscriber computing device 606c displays the local advertisement as illustrated in screenshot 608c.

FIG. 6D illustrate exemplary subscriber computing devices 604d and 608d utilizing a supplemental media delivery system 600d. The system 600d includes the subscriber computing device 604d, the subscriber computing device 608d, a communication network 625d, a content analysis server 610d, a content provider A 620d, and a content provider B 640d. A user 601d utilizes the subscriber computing devices 604d and 606d to access and/or view media (e.g., a television show, a movie, an advertisement, a website, etc.). As illustrated in screenshot 602d of the subscriber computing device 604d, the subscriber computing device 604d displays a cooking show trailer supplied by the content provider A 620d. The content analysis server 610d analyzes the cooking show trailer to determine information (in this example, trailer id=CookTrailerAB342) and transmits the information to the content provider B 640d.

The content provider B 640d determines a related trailer based on the information (in this example, a database lookup of the trailer id to identify the related trailer) and transmits the related trailer to the subscriber computing device 606d. The subscriber computing device 606d displays the related trailer as illustrated in screenshot 608d.

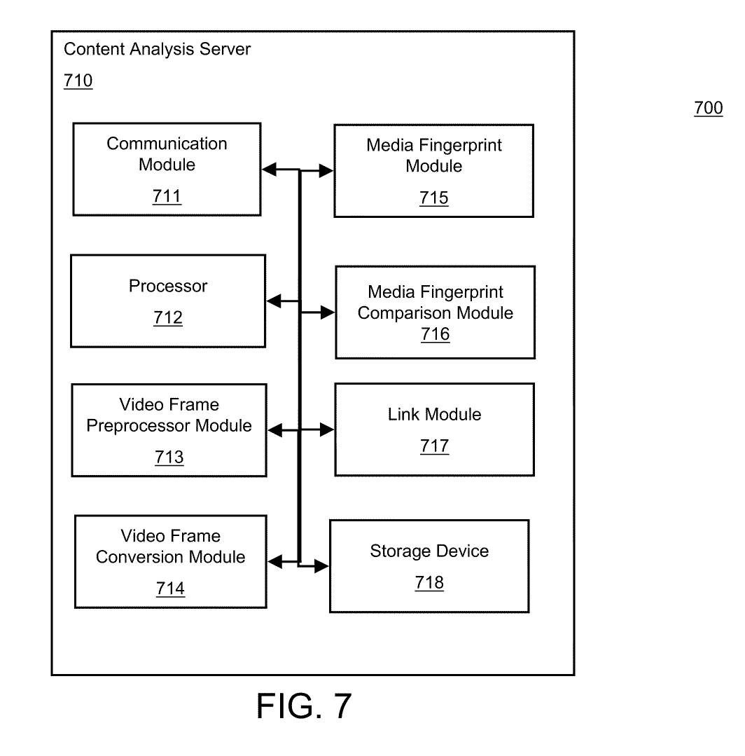

FIG. 7 is a block diagram of an exemplary content analysis server 710 in a advertisement management system 700. The content analysis server 710 includes a communication module 711, a processor 712, a video frame preprocessor module 713, a video frame conversion module 714, a media fingerprint module 715, a media fingerprint comparison module 716, a link module 717, and a storage device 718.

The communication module 711 receives information for and/or transmits information from the content analysis server 710. The processor 712 processes requests for comparison of multimedia streams (e.g., request from a user, automated request from a schedule server, etc.) and instructs the communication module 711 to request and/or receive multimedia streams. The video frame preprocessor module 713 preprocesses multimedia streams (e.g., remove black border, insert stable borders, resize, reduce, selects key frame, groups frames together, etc.). The video frame conversion module 714 converts the multimedia streams (e.g., luminance normalization, RGB to Color9, etc.).

The media fingerprint module 715 generates a fingerprint (generally referred to as a descriptor or signature) for each key frame selection (e.g., each frame is its own key frame selection, a group of frames have a key frame selection, etc.) in a multimedia stream. The media fingerprint comparison module 716 compares the frame sequences for multimedia streams to identify similar frame sequences between the multimedia streams (e.g., by comparing the fingerprints of each key frame selection of the frame sequences, by comparing the fingerprints of each frame in the frame sequences, etc.).

The link module 717 determines a link (e.g., URL, computer readable location indicator, etc.) for media based on one or more stored links and/or requests a link from an advertisement server (not shown). The storage device 718 stores a request, media, metadata, a descriptor, a frame selection, a frame sequence, a comparison of the frame sequences, and/or any other information associated with the association of metadata.

In some examples, the video frame conversion module 714 determines one or more boundaries associated with the media data. The media fingerprint module 715 generates one or more descriptors based on the media data and the one or more boundaries. Table 2 illustrates the boundaries determined by the video frame conversion module 714 for an advertisement “Big Dog Food is Great!”

TABLE 2
Exemplary Boundaries and Descriptors for Advertisement

| Boundary Start | Boundary End | Descriptor |
|---|---|---|
| 00:00:00 | 03:34:43 | Alpha45c |
| 03:34:44 | 05:42:22 | Alpha45d |
| 05:42:23 | 06:42:22 | Alpha45e |
| 06:42:23 | 08:23:23 | Alpha45g |

In other examples, the media fingerprint comparison module 716 compares the one or more descriptors and one or more other descriptors. Each of the one or more other descriptors can be associated with one or more other boundaries associated with the other media data. For example, the media fingerprint comparison module 716 compares the one or more descriptors (e.g., Alpha 45e, Alpha 45g, etc.) with stored descriptors. The comparison of the descriptors can be, for example, an exact comparison (e.g., text to text comparison, bit to bit comparison, etc.), a similarity comparison (e.g., descriptors are within a specified range, descriptors are within a percentage range, etc.), and/or any other type of comparison. The media fingerprint comparison module 716 can, for example, determine an identification about the media data based on exact matches of the descriptors and/or can associate part or all of the identification about the media data based on a similarity match of the descriptors. Table 3 illustrates the comparison of the descriptors with other descriptors.

TABLE 3
Exemplary Comparison of Descriptors

| | Stored | | | |
|---|---|---|---|---|
| Descriptor | Descriptors | Stored Identification | Result | Associated Identification |
| Alpha45g | Alpha45a | Advertisement: “Big Dog Food | Similar | Advertisement: “Big Dog Food |
| | | is Great!”; Part A | | is Great!” |
| | Alpha45b | Advertisement: “Big Dog Food | Similar | Advertisement: “Big Dog Food |
| | | is Great!”; Part B | | is Great!” |
| | Beta34a | Television Show “Why Cats | No Match | NA |
| | | are Great”; Part A | | |
| | Beta34b | Television Show “Why Cats | No Match | NA |
| | | are Great”; Part B | | |
| | Alpha45g | Advertisement: “Big Dog Food | Match | Advertisement: “Big Dog Food |
| | | is Great!”; Part G | | is Great!” |
| Beta45c | Alpha45a | Advertisement: “Big Dog Food | No Match | NA |
| | | is Great!”; Part A | | |
| | Alpha45b | Advertisement: “Big Dog Food | No Match | NA |
| | | is Great!”; Part B | | |
| | Beta34a | Television Show “Why Cats | Similar | Television Show “Why Cats are |
| | | are Great”; Part A | | Great” |
| | Beta34b | Television Show “Why Cats | Similar | Television Show “Why Cats are |
| | | are Great”; Part B | | Great” |
| | Alpha45g | Advertisement: “Big Dog Food | No Match | NA |
| | | is Great!”; Part G | | |

In other examples, the video frame conversion module 714 separates the media data into one or more media data sub-parts based on the one or more boundaries. In some examples, the media fingerprint comparison module 716 associates at least part of the identification with at least one of the one or more media data sub-parts based on the comparison of the descriptor and the other descriptor. For example, a televised movie can be split into sub-parts based on the movie sub-parts and the commercial sub-parts as illustrated in Table 1.

In some examples, the communication module 711 receives the media data and the identification associated with the media data. The media fingerprint module 715 generates the descriptor based on the media data. For example, the communication module 711 receives the media data, in this example, a movie, from a digital video disc (DVD) player and the metadata from an internet movie database. In this example, the media fingerprint module 715 generates a descriptor of the movie and associates the identification with the descriptor.

In other examples, the media fingerprint comparison module 716 associates at least part of the identification with the descriptor. For example, the television show name is associated with the descriptor, but not the first air date.

In some examples, the storage device 718 stores the identification, the first descriptor, and/or the association of the at least part of the identification with the first descriptor. The storage device 718 can, for example, retrieve the stored identification, the stored first descriptor, and/or the stored association of the at least part of the identification with the first descriptor.

In some examples, the media fingerprint comparison module 716 determines new and/or supplemental identification for media by accessing third party information sources. The media fingerprint comparison module 716 can request identification associated with media from an internet database (e.g., internet movie database, internet music database, etc.) and/or a third party commercial database (e.g., movie studio database, news database, etc.). For example, the identification associated with media (in this example, a movie) includes the title “All Dogs go to Heaven” and the movie studio “Dogs Movie Studio.” Based on the identification, the media fingerprint comparison module 716 requests additional identification from the movie studio database, receives the additional identification (in this example, release date: “Jun. 1, 1995”; actors: W of Gang McRuff and Ruffus T. Bone; running time: 2:03:32), and associates the additional identification with the media.

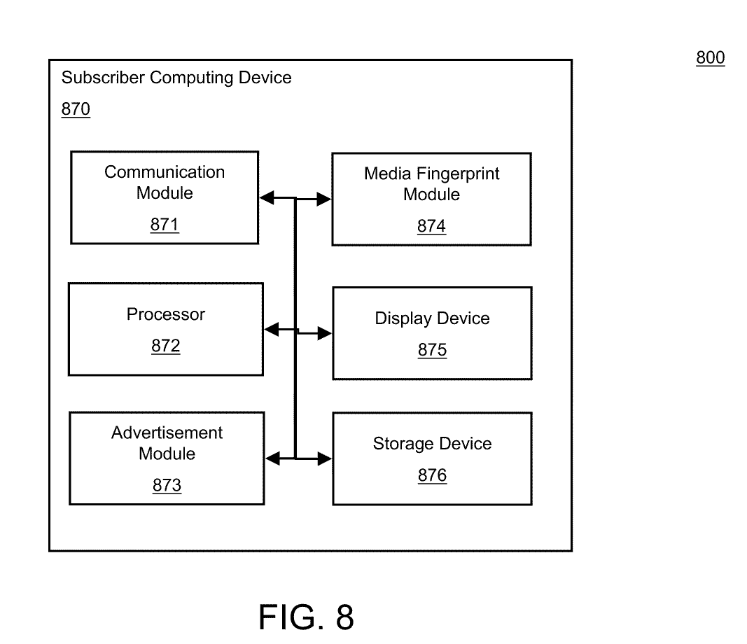

FIG. 8 is a block diagram of an exemplary subscriber computing device 870 in a advertisement management system 800. The subscriber computing device 870 includes a communication module 871, a processor 872, an advertisement module 873, a media fingerprint module 874, a display device 875 (e.g., a monitor, a mobile device screen, a television, etc.), and a storage device 876.

The communication module 871 receives information for and/or transmits information from the subscriber computing device 870. The processor 872 processes requests for comparison of media streams (e.g., request from a user, automated request from a schedule server, etc.) and instructs the communication module 711 to request and/or receive media streams. The advertisement module 873 requests advertisements from an advertisement server (not shown) and/or transmits requests for comparison of descriptors to a content analysis server (not shown).

The media fingerprint module 874 generates a fingerprint for each key frame selection (e.g., each frame is its own key frame selection, a group of frames have a key frame selection, etc.) in a media stream. The media fingerprint module 874 associates identification with media and/or determines the identification from media (e.g., extracts metadata from media, determines metadata for media, etc.). The display device 875 displays a request, media, identification, a descriptor, a frame selection, a frame sequence, a comparison of the frame sequences, and/or any other information associated with the association of identification. The storage device 876 stores a request, media, identification, a descriptor, a frame selection, a frame sequence, a comparison of the frame sequences, and/or any other information associated with the association of identification.

In other examples, the subscriber computing device 870 utilizes media editing software and/or hardware (e.g., Adobe Premiere available from Adobe Systems Incorporate, San Jose, Calif.; Corel VideoStudio® available from Corel Corporation, Ottawa, Canada, etc.) to manipulate and/or process the media. The editing software and/or hardware can include an application link (e.g., button in the user interface, drag and drop interface, etc.) to transmit the media being edited to the content analysis server to associate the applicable identification with the media, if possible.

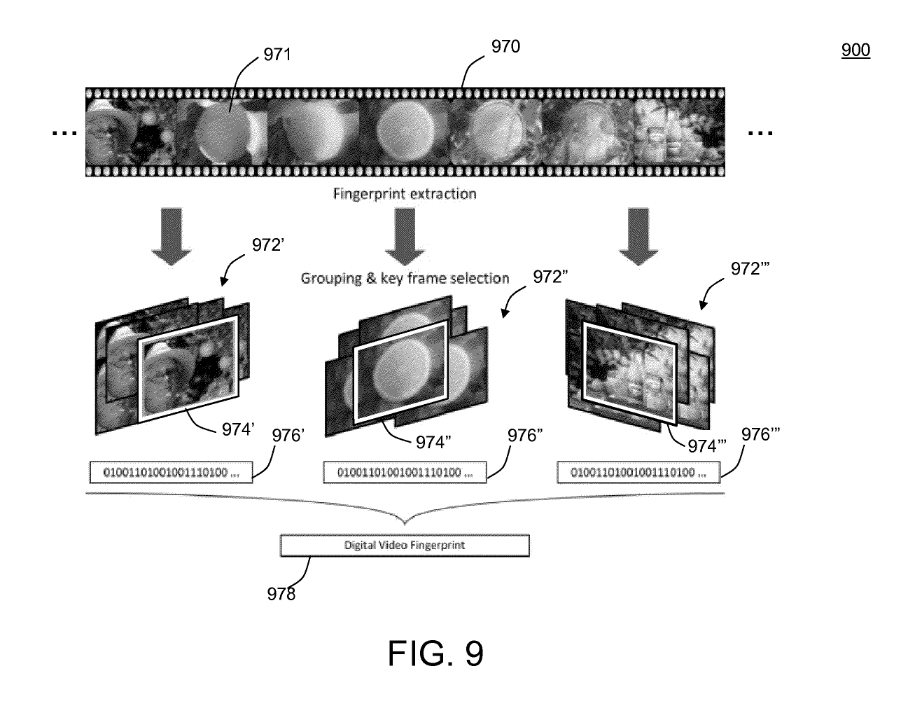

FIG. 9 illustrates an exemplary flow diagram 900 of a generation of a digital video fingerprint. The content analysis units fetch the recorded data chunks (e.g., multimedia content) from the signal buffer units directly and extract fingerprints prior to the analysis. The content analysis server 310 of FIG. 3 receives one or more video (and more generally audiovisual) clips or segments 970, each including a respective sequence of image frames 971. Video image frames are highly redundant, with groups frames varying from each other according to different shots of the video segment 970. In the exemplary video segment 970, sampled frames of the video segment are grouped according to shot: a first shot 972′, a second shot 972″, and a third shot 972′. A representative frame, also referred to as a key frame 974′, 974″, 974′ (generally 974) is selected for each of the different shots 972′, 972″, 972′ (generally 972). The content analysis server 100 determines a respective digital signature 976′, 976″, 976′ (generally 976) for each of the different key frames 974. The group of digital signatures 976 for the key frames 974 together represent a digital video fingerprint 978 of the exemplary video segment 970.

In some examples, a fingerprint is also referred to as a descriptor. Each fingerprint can be a representation of a frame and/or a group of frames. The fingerprint can be derived from the content of the frame (e.g., function of the colors and/or intensity of an image, derivative of the parts of an image, addition of all intensity value, average of color values, mode of luminance value, spatial frequency value). The fingerprint can be an integer (e.g., 345, 523) and/or a combination of numbers, such as a matrix or vector (e.g., [a, b], [x, y, z]). For example, the fingerprint is a vector defined by [x, y, z] where x is luminance, y is chrominance, and z is spatial frequency for the frame.

In some embodiments, shots are differentiated according to fingerprint values. For example in a vector space, fingerprints determined from frames of the same shot will differ from fingerprints of neighboring frames of the same shot by a relatively small distance. In a transition to a different shot, the fingerprints of a next group of frames differ by a greater distance. Thus, shots can be distinguished according to their fingerprints differing by more than some threshold value.

Thus, fingerprints determined from frames of a first shot 972′ can be used to group or otherwise identify those frames as being related to the first shot. Similarly, fingerprints of subsequent shots can be used to group or otherwise identify subsequent shots 972″, 972″. A representative frame, or key frame 974′, 974″, 974′″ can be selected for each shot 972. In some embodiments, the key frame is statistically selected from the fingerprints of the group of frames in the same shot (e.g., an average or centroid).

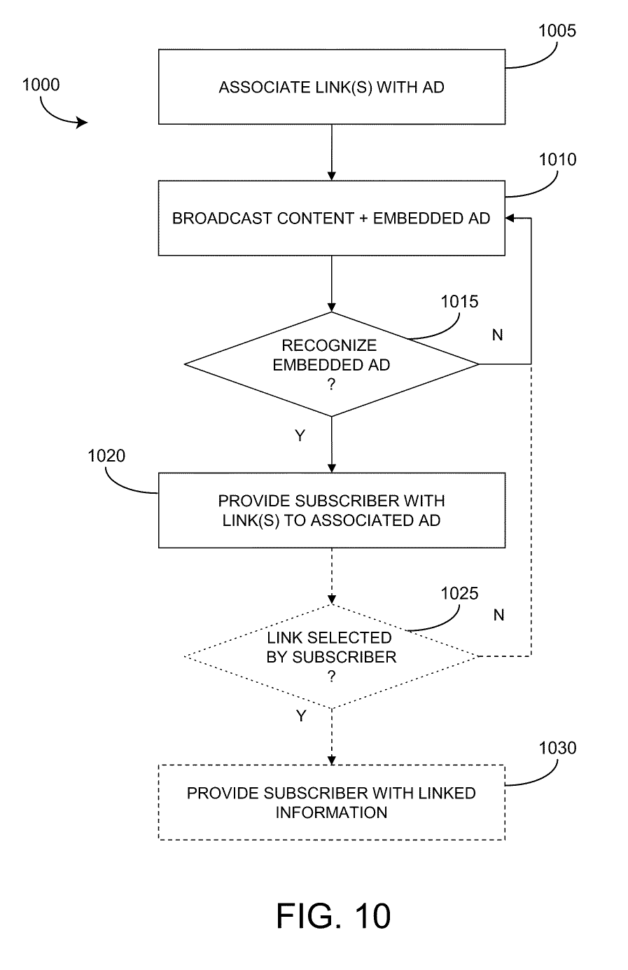

FIG. 10 shows an exemplary flow diagram for managing an advertisement campaign. One or more links are associated with a target advertisement (reference numeral 1005). The ads are embedded together with content in a combined media broadcast of the content and embedded ads (reference numeral 1010). An ad monitor receives the combined media broadcast, searching for occurrences of a target advertisement (reference numeral 1015). Upon occurrence of the target ad within the combined media broadcast (real time, or at least near real time), subscribers of the combined media broadcast are also presented with indicia of the one or more links associated with the target ad (reference numeral 1020). Subscribers may click-through or otherwise select at least one of the one or more links to obtain any information linked therewith (reference numeral 1025). A subscriber is presented with such linked information (reference numeral 1030).

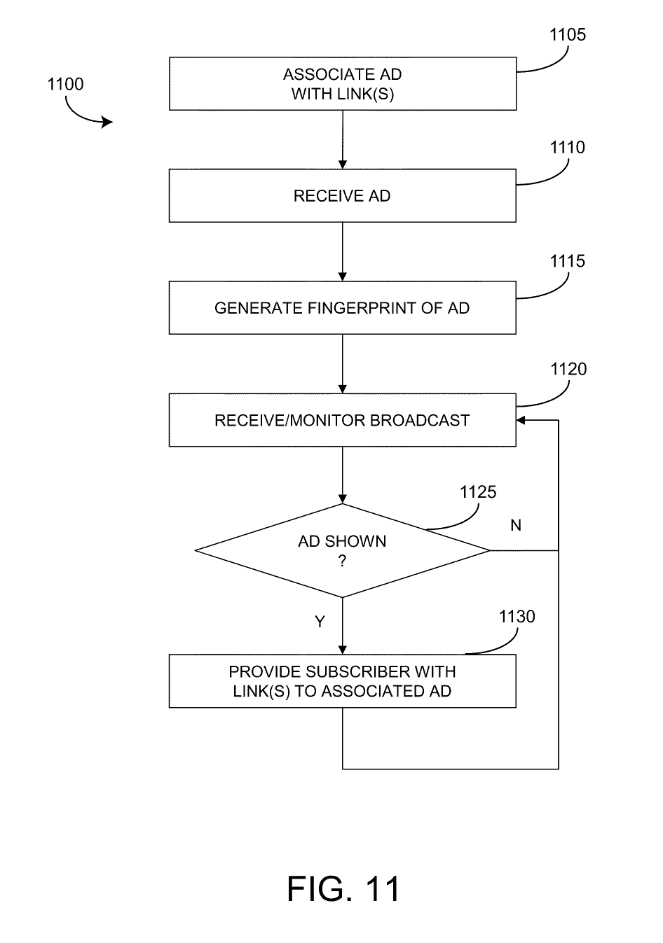

FIG. 11 shows another exemplary flow diagram for managing an advertisement campaign. One or more links are associated with a target advertisement (reference numeral 1105). The target advertisement is received by an ad monitor (reference numeral 1110), which retains indicia of the target ad (reference numeral 1115). In some embodiments, the ad monitor generates a processed representation of the target advertisement. At least some such processed representations can be referred to as fingerprints. The fingerprints may include one or more of video and audio information of the target ad. Examples of such fingerprinting are provided below. The ad monitor receives the media broadcast including content and embedded ads (reference numeral 1120). The ad monitor determines whether any target ads have been included (i.e., shown) within the media broadcast (reference numeral 1125). Upon detection of a target ad within the media broadcast, or shortly thereafter, a subscriber is presented with the one or more links pre-associated with the target advertisement (reference numeral 1130).

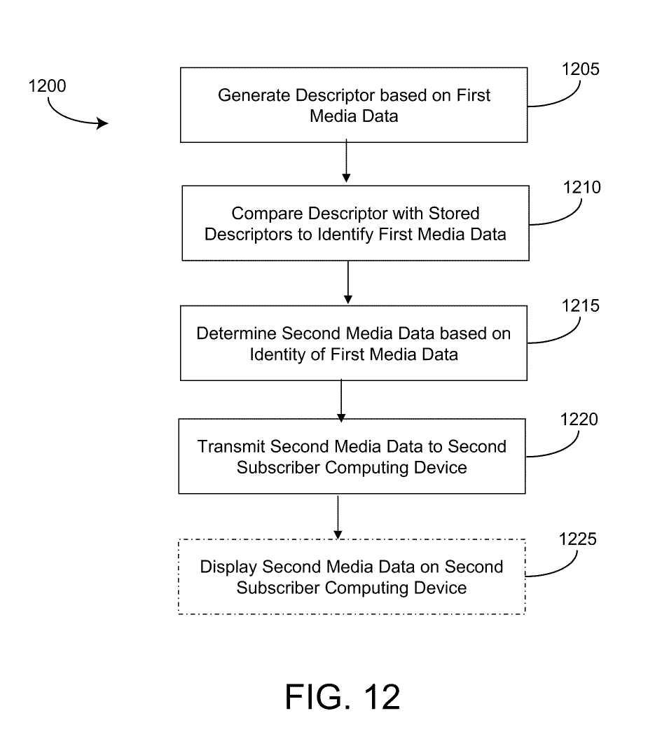

FIG. 12 shows another exemplary flow diagram for supplemental media delivery. A first descriptor is generated based on first media data (reference numeral 1205). The first media data may be associated with a first subscriber computing device. The first descriptor is compared with other stored descriptors (reference numeral 1210). The first media data may be identified based on the comparison. Second media data is determined based on the identity of the first media data identified by comparing the descriptors (reference numeral 1215). The second media data is transmitted to a second subscriber computing device (reference numeral 1220). The second media data may be displayed on the second subscriber computing device (reference numeral 1225).

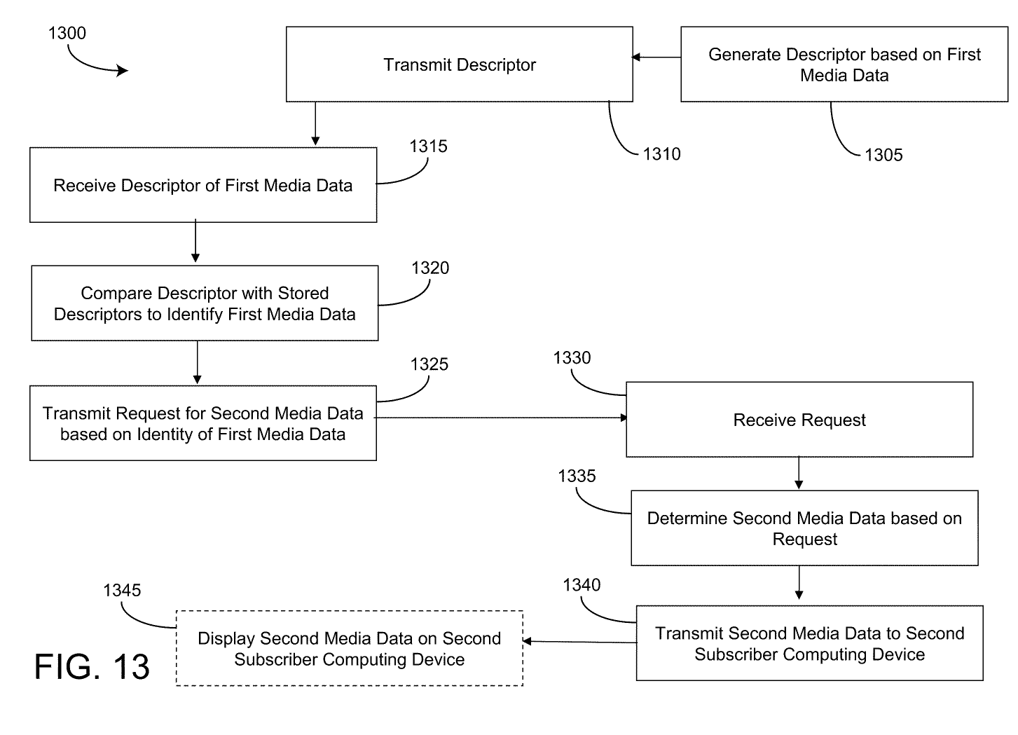

FIG. 13 shows another exemplary flow diagram for supplemental media delivery. A first descriptor is generated based on first media data (reference numeral 1305). The first media data may be associated with a first subscriber computing device. The first descriptor is transmitted from the first subscriber computing device to an ad monitor (reference numeral 1310). The ad monitor receives the first descriptor (reference numeral 1315). The first descriptor is compared with other stored descriptors (reference numeral 1320). The first media data may be identified based on the comparison. A request for second media data is transmitted (e.g., from an operator to an advertiser) based on the determined identity of the first media data (reference numeral 1325). The request is received (reference numeral 1330) and second media data is determined based on the request (reference numeral 1335). The second media data is transmitted to a second subscriber computing device (reference numeral 1340). The second media data may be displayed on the second subscriber computing device (reference numeral 1345).

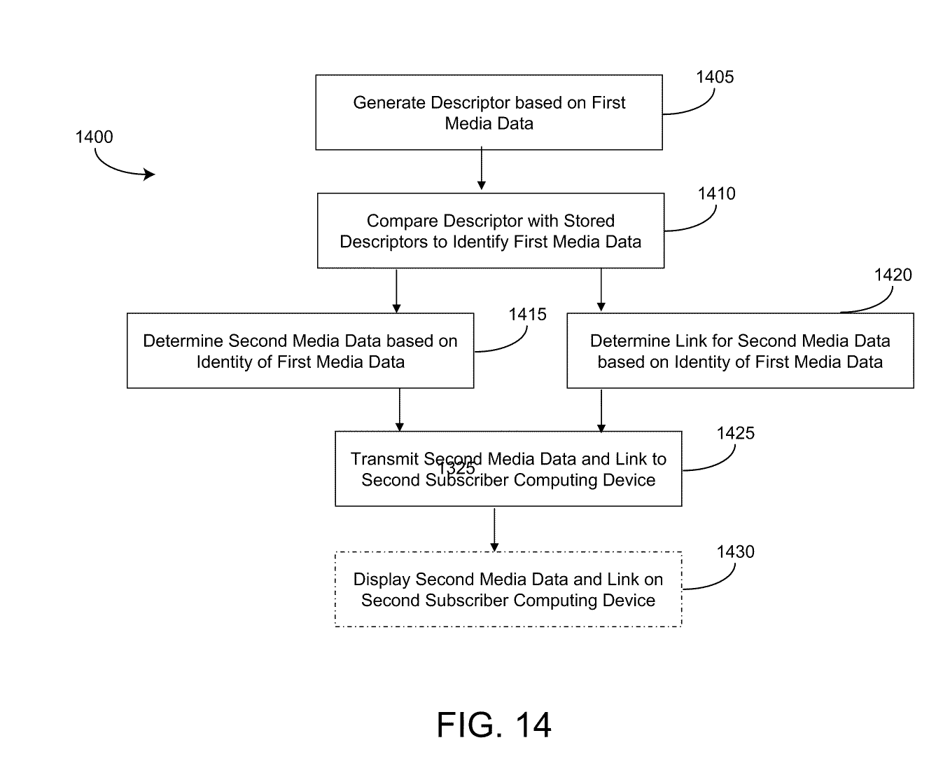

FIG. 14 shows another exemplary flow diagram for supplemental media delivery. A first descriptor is generated based on first media data (reference numeral 1405). The first media data may be associated with a first subscriber computing device. The first descriptor is compared with other stored descriptors (reference numeral 1410). The first media data may be identified based on the comparison. Second media data (reference numeral 1415) and a link for the second media data (reference numeral 1420) are determined based on the identity of the first media data identified by comparing the descriptors. The second media data is transmitted to a second subscriber computing device (reference numeral 1425). The second media data may be displayed on the second subscriber computing device (reference numeral 1430).

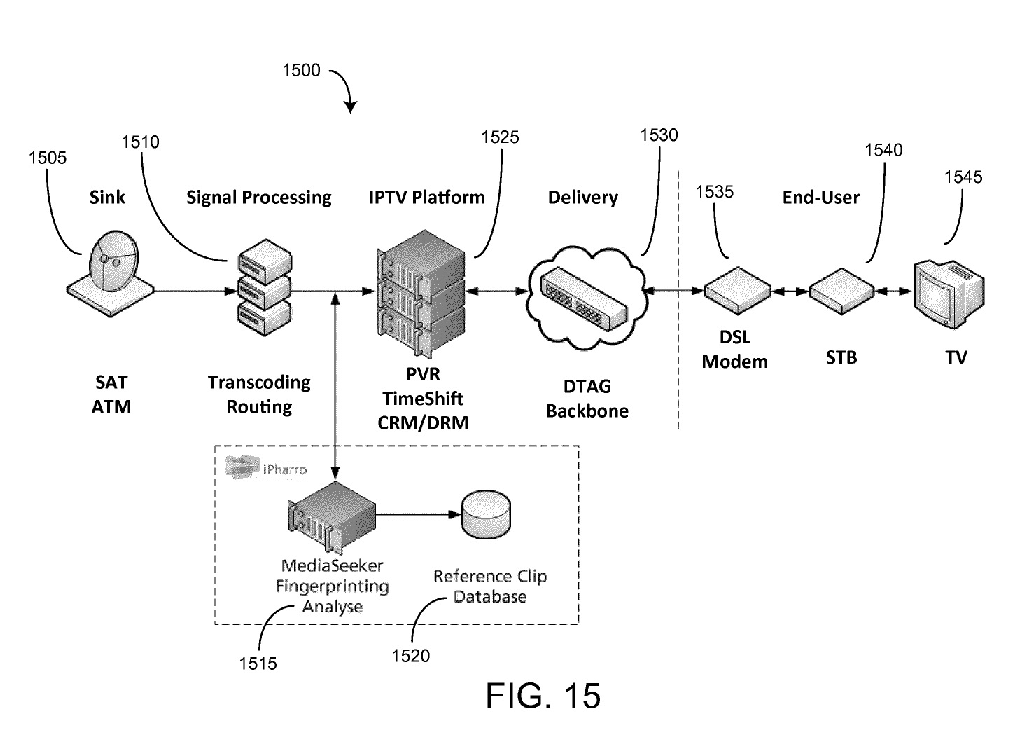

FIG. 15 illustrates another exemplary block diagram of a system 1500 for managing an advertisement campaign. A signal receiver 1505 is configured to receive a signal (e.g., via a satellite transmission system) including and/or representing media content (e.g., a video signal). A signal processor 1510 is configured to process the received signal may include transcoding the signal, or converting the signal to a different type of encoding. The signal processor 1510 may also be configured to route the signal to one or more appropriate devices. A fingerprinting analysis engine 1515 is configured to receive the processed media signal, analyze the signal, and compare the signal to other signals or clips stored in a reference database 1520. For example, the fingerprinting analysis engine 1515 may be configured to determine one or more descriptors related to the media signal and compare them to descriptors stored in the reference database 1520. The fingerprinting analysis engine 1515 may be configured to generate other signals to be passed on to other devices based on the comparison.

A signal manipulation device 1525 is configured to receive media signals from the signal processor 1510 and/or the fingerprinting analysis engine 1515 and conduct further operations on the media signals. The operations may include, for example, operations relating to personal video recording capabilities, timeshifting of media signals, digital rights management, etc. The media signals may then be delivered to one or more end-users using a delivery device 1530.

An end-user may receive the media signals at a model 1535 (e.g., DSL modem, cable modem, etc.). The media signals may then be relayed to a set top box 1540 and subsequently sent to a display device 1545 (e.g., a television, computer, mobile computing device, etc.) for viewing.

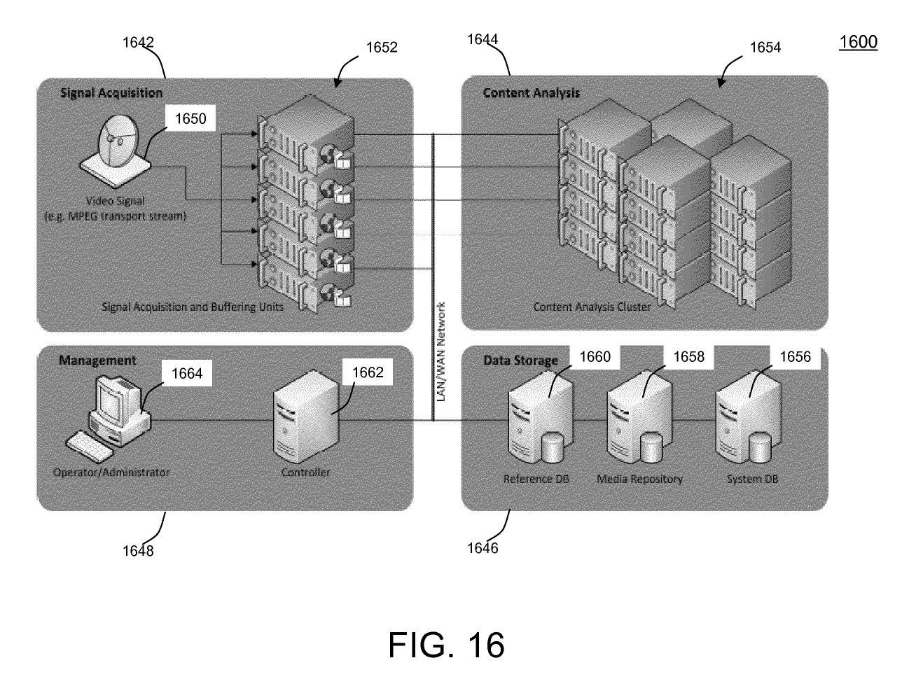

FIG. 16 illustrates a block diagram of an exemplary multi-channel video monitoring system 1600. The system 1600 includes (i) a signal, or media acquisition subsystem 1642, (ii) a content analysis subsystem 1644, (iii) a data storage subsystem 446, and (iv) a management subsystem 1648.

The media acquisition subsystem 1642 acquires one or more video signals 1650. For each signal, the media acquisition subsystem 1642 records it as data chunks on a number of signal buffer units 1652. Depending on the use case, the buffer units 1652 may perform fingerprint extraction as well, as described in more detail herein. This can be useful in a remote capturing scenario in which the very compact fingerprints are transmitted over a communications medium, such as the Internet, from a distant capturing site to a centralized content analysis site. The video detection system and processes may also be integrated with existing signal acquisition solutions, as long as the recorded data is accessible through a network connection.

The fingerprint for each data chunk can be stored in a media repository 1658 portion of the data storage subsystem 1646. In some embodiments, the data storage subsystem 1646 includes one or more of a system repository 1656 and a reference repository 1660. One or more of the repositories 1656, 1658, 1660 of the data storage subsystem 1646 can include one or more local hard-disk drives, network accessed hard-disk drives, optical storage units, random access memory (RAM) storage drives, and/or any combination thereof. One or more of the repositories 1656, 1658, 1660 can include a database management system to facilitate storage and access of stored content. In some embodiments, the system 1640 supports different SQL-based relational database systems through its database access layer, such as Oracle and Microsoft-SQL Server. Such a system database acts as a central repository for all metadata generated during operation, including processing, configuration, and status information.

In some embodiments, the media repository 1658 is serves as the main payload data storage of the system 1640 storing the fingerprints, along with their corresponding key frames. A low quality version of the processed footage associated with the stored fingerprints is also stored in the media repository 1658. The media repository 1658 can be implemented using one or more RAID systems that can be accessed as a networked file system.

Each of the data chunk can become an analysis task that is scheduled for processing by a controller 1662 of the management subsystem 1648. The controller 1662 is primarily responsible for load balancing and distribution of jobs to the individual nodes in a content analysis cluster 1654 of the content analysis subsystem 1644. In at least some embodiments, the management subsystem 1648 also includes an operator/administrator terminal, referred to generally as a front-end 1664. The operator/administrator terminal 1664 can be used to configure one or more elements of the video detection system 1640. The operator/administrator terminal 1664 can also be used to upload reference video content for comparison and to view and analyze results of the comparison.

The signal buffer units 1652 can be implemented to operate around-the-clock without any user interaction necessary. In such embodiments, the continuous video data stream is captured, divided into manageable segments, or chunks, and stored on internal hard disks. The hard disk space can be implanted to function as a circular buffer. In this configuration, older stored data chunks can be moved to a separate long term storage unit for archival, freeing up space on the internal hard disk drives for storing new, incoming data chunks. Such storage management provides reliable, uninterrupted signal availability over very long periods of time (e.g., hours, days, weeks, etc.). The controller 1662 is configured to ensure timely processing of all data chunks so that no data is lost. The signal acquisition units 1652 are designed to operate without any network connection, if required, (e.g., during periods of network interruption) to increase the system's fault tolerance.

In some embodiments, the signal buffer units 1652 perform fingerprint extraction and transcoding on the recorded chunks locally. Storage requirements of the resulting fingerprints are trivial compared to the underlying data chunks and can be stored locally along with the data chunks. This enables transmission of the very compact fingerprints including a storyboard over limited-bandwidth networks, to avoid transmitting the full video content.

In some embodiments, the controller 1662 manages processing of the data chunks recorded by the signal buffer units 1652. The controller 1662 constantly monitors the signal buffer units 1652 and content analysis nodes 1654, performing load balancing as required to maintain efficient usage of system resources. For example, the controller 1662 initiates processing of new data chunks by assigning analysis jobs to selected ones of the analysis nodes 1654. In some instances, the controller 1662 automatically restarts individual analysis processes on the analysis nodes 1654, or one or more entire analysis nodes 1654, enabling error recovery without user interaction. A graphical user interface, can be provided at the front end 1664 for monitor and control of one or more subsystems 1642, 1644, 1646 of the system 1600. For example, the graphical user interface allows a user to configure, reconfigure and obtain status of the content analysis 1644 subsystem.

In some embodiments, the analysis cluster 1644 includes one or more analysis nodes 1654 as workhorses of the video detection and monitoring system. Each analysis node 1654 independently processes the analysis tasks that are assigned to them by the controller 1662. This primarily includes fetching the recorded data chunks, generating the video fingerprints, and matching of the fingerprints against the reference content. The resulting data is stored in the media repository 1658 and in the data storage subsystem 1646. The analysis nodes 1654 can also operate as one or more of reference clips ingestion nodes, backup nodes, or RetroMatch nodes, in case the system performing retrospective matching. Generally, all activity of the analysis cluster is controlled and monitored by the controller.

After processing several such data chunks 1670, the detection results for these chunks are stored in the system database 1656. Beneficially, the numbers and capacities of signal buffer units 1652 and content analysis nodes 1654 may flexibly be scaled to customize the system's capacity to specific use cases of any kind Realizations of the system 1600 can include multiple software components that can be combined and configured to suit individual needs. Depending on the specific use case, several components can be run on the same hardware. Alternatively or in addition, components can be run on individual hardware for better performance and improved fault tolerance. Such a modular system architecture allows customization to suit virtually every possible use case. From a local, single-PC solution to nationwide monitoring systems, fault tolerance, recording redundancy, and combinations thereof.

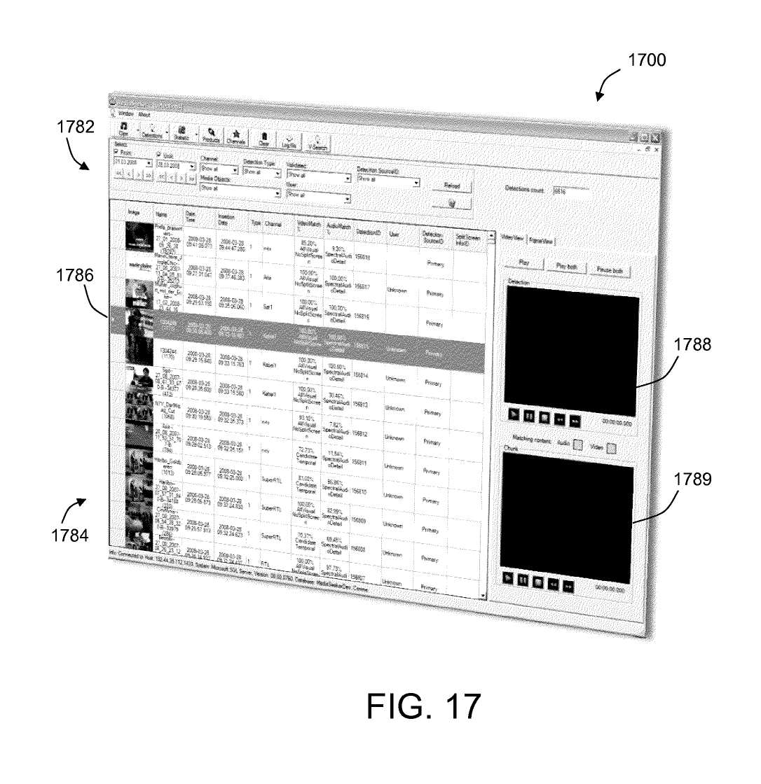

FIG. 17 illustrates a screen shot of an exemplary graphical user interface (GUI) 1700. The GUI 1700 can be utilized by operators, data annalists, and/or other users of the system 300 of FIG. 3 to operate and/or control the content analysis server 110. The GUI 1700 enables users to review detections, manage reference content, edit clip metadata, play reference and detected multimedia content, and perform detailed comparison between reference and detected content. In some embodiments, the system 1600 includes or more different graphical user interfaces, for different functions and/or subsystems such as the a recording selector, and a controller front-end 1664.

The GUI 1700 includes one or more user-selectable controls 1782, such as standard window control features. The GUI 1700 also includes a detection results table 1784. In the exemplary embodiment, the detection results table 1784 includes multiple rows 1786, one row for each detection. The row 1786 includes a low-resolution version of the stored image together with other information related to the detection itself. Generally, a name or other textual indication of the stored image can be provided next to the image. The detection information can include one or more of: date and time of detection; indicia of the channel or other video source; indication as to the quality of a match; indication as to the quality of an audio match; date of inspection; a detection identification value; and indication as to detection source. In some embodiments, the GUI 1700 also includes a video viewing window 1788 for viewing one or more frames of the detected and matching video. The GUI 1700 can include an audio viewing window 1789 for comparing indicia of an audio comparison.

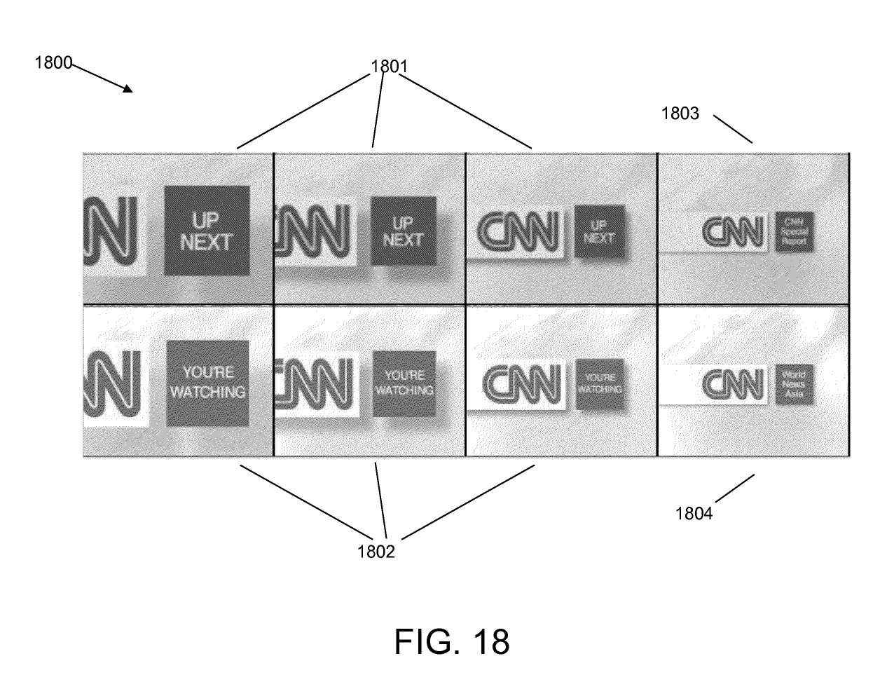

FIG. 18 illustrates an example of a change in a digital image representation subframe. A set of one of: target file image subframes and queried image subframes 1800 are shown, wherein the set 1800 includes subframe sets 1801, 1802, 1803, and 1804. Subframe sets 1801 and 1802 differ from other set members in one or more of translation and scale. Subframe sets 1802 and 1803 differ from each other, and differ from subframe sets 1801 and 1802, by image content and present an image difference to a subframe matching threshold.

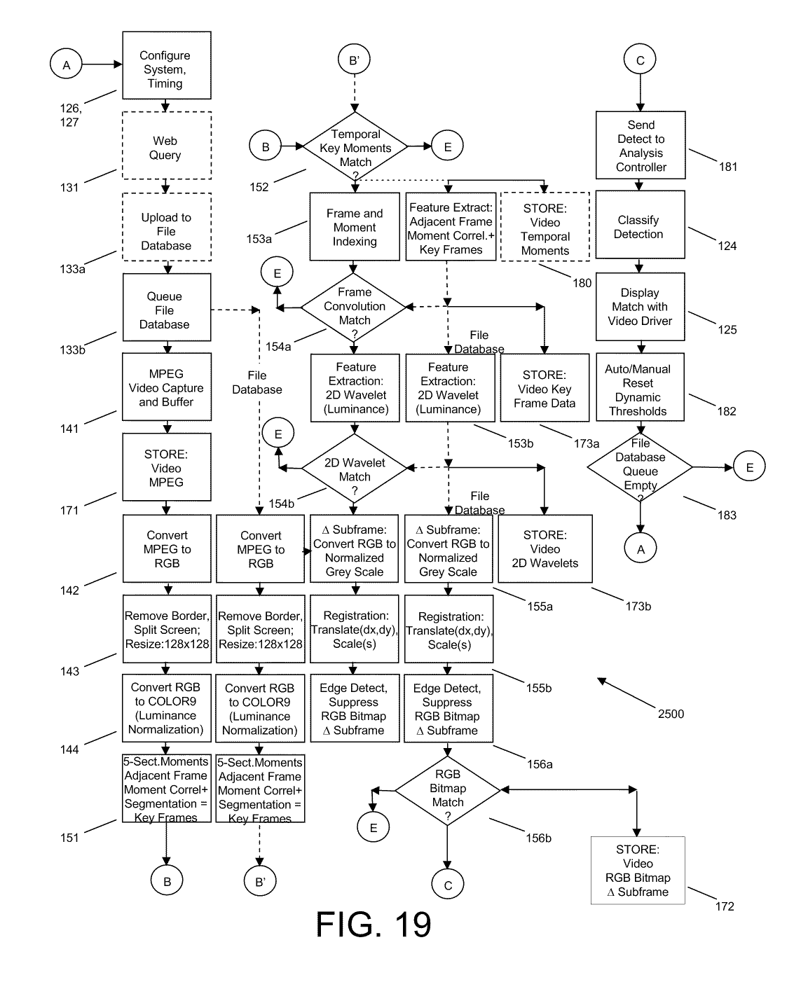

FIG. 19 illustrates an exemplary flow chart 1900 for the digital video image detection system 1600 of FIG. 16. The flow chart 1900 initiates at a start point A with a user at a user interface configuring the digital video image detection system 126, wherein configuring the system may include selecting at least one channel, at least one decoding method, and a channel sampling rate, a channel sampling time, and a channel sampling period. Configuring the system 126 includes one of: configuring the digital video image detection system manually and semi-automatically. Configuring the system 126 semi-automatically includes one or more of: selecting channel presets, scanning scheduling codes, and receiving scheduling feeds.

Configuring the digital video image detection system 126 further includes generating a timing control sequence 127, wherein a set of signals generated by the timing control sequence 127 provide for an interface to an MPEG video receiver.

In some embodiments, the method flow chart 1900 for the digital video image detection system 300 provides for optionally querying the web for a file image 131 for the digital video image detection system 300 to match. In some embodiments, the method flow chart 1900 provides for optionally uploading from the user interface 100 a file image for the digital video image detection system 300 to match. In some embodiments, querying and queuing a file database 133b provides for at least one file image for the digital video image detection system 300 to match.

The method flow chart 1900 further provides for capturing and buffering an MPEG video input at the MPEG video receiver (reference numeral 141) and for storing the MPEG video input 171 as a digital image representation in an MPEG video archive.

The method flow chart 1900 further provides for: converting the MPEG video image to a plurality of query digital image representations, converting the file image to a plurality of file digital image representations, wherein the converting the MPEG video image and the converting the file image are comparable methods, and comparing and matching the queried and file digital image representations. Converting the file image to a plurality of file digital image representations is provided by one of: converting the file image at the time the file image is uploaded, converting the file image at the time the file image is queued, and converting the file image in parallel with converting the MPEG video image.

The method flow chart 1900 provides for a method 142 for converting the MPEG video image and the file image to a queried RGB digital image representation and a file RGB digital image representation, respectively. In some embodiments, converting method 142 further comprises removing an image border 143 from the queried and file RGB digital image representations. In some embodiments, the converting method 142 further comprises removing a split screen 143 from the queried and file RGB digital image representations. In some embodiment, one or more of removing an image border and removing a split screen 143 includes detecting edges. In some embodiments, converting method 142 further comprises resizing the queried and file RGB digital image representations to a size of 128×128 pixels.

The method flow chart 1900 further provides for a method 144 for converting the MPEG video image and the file image to a queried COLOR9 digital image representation and a file COLOR9 digital image representation, respectively. Converting method 144 provides for converting directly from the queried and file RGB digital image representations.

Converting method 144 includes: projecting the queried and file RGB digital image representations onto an intermediate luminance axis, normalizing the queried and file RGB digital image representations with the intermediate luminance, and converting the normalized queried and file RGB digital image representations to a queried and file COLOR9 digital image representation, respectively.

The method flow chart 1900 further provides for a method 151 for converting the MPEG video image and the file image to a queried 5-segment, low resolution temporal moment digital image representation and a file 5-segment, low resolution temporal moment digital image representation, respectively. Converting method 151 provides for converting directly from the queried and file COLOR9 digital image representations.

Converting method 151 includes: sectioning the queried and file COLOR9 digital image representations into five spatial, overlapping sections and non-overlapping sections, generating a set of statistical moments for each of the five sections, weighting the set of statistical moments, and correlating the set of statistical moments temporally, generating a set of key frames or shot frames representative of temporal segments of one or more sequences of COLOR9 digital image representations.

Generating the set of statistical moments for converting method 151 includes generating one or more of: a mean, a variance, and a skew for each of the five sections. In some embodiments, correlating a set of statistical moments temporally for converting method 151 includes correlating one or more of a means, a variance, and a skew of a set of sequentially buffered RGB digital image representations.

Correlating a set of statistical moments temporally for a set of sequentially buffered MPEG video image COLOR9 digital image representations allows for a determination of a set of median statistical moments for one or more segments of consecutive COLOR9 digital image representations. The set of statistical moments of an image frame in the set of temporal segments that most closely matches the a set of median statistical moments is identified as the shot frame, or key frame. The key frame is reserved for further refined methods that yield higher resolution matches.

The method flow chart 1900 further provides for a comparing method 152 for matching the queried and file 5-section, low resolution temporal moment digital image representations. In some embodiments, the first comparing method 152 includes finding an one or more errors between the one or more of: a mean, variance, and skew of each of the five segments for the queried and file 5-section, low resolution temporal moment digital image representations. In some embodiments, the one or more errors are generated by one or more queried key frames and one or more file key frames, corresponding to one or more temporal segments of one or more sequences of COLOR9 queried and file digital image representations. In some embodiments, the one or more errors are weighted, wherein the weighting is stronger temporally in a center segment and stronger spatially in a center section than in a set of outer segments and sections.

Comparing method 152 includes a branching element ending the method flow chart 2500 at ‘E’ if the first comparing results in no match. Comparing method 152 includes a branching element directing the method flow chart 1900 to a converting method 153 if the comparing method 152 results in a match.

In some embodiments, a match in the comparing method 152 includes one or more of: a distance between queried and file means, a distance between queried and file variances, and a distance between queried and file skews registering a smaller metric than a mean threshold, a variance threshold, and a skew threshold, respectively. The metric for the first comparing method 152 can be any of a set of well known distance generating metrics.

A converting method 153a includes a method of extracting a set of high resolution temporal moments from the queried and file COLOR9 digital image representations, wherein the set of high resolution temporal moments include one or more of: a mean, a variance, and a skew for each of a set of images in an image segment representative of temporal segments of one or more sequences of COLOR9 digital image representations.

Converting method 153a temporal moments are provided by converting method 151. Converting method 153a indexes the set of images and corresponding set of statistical moments to a time sequence. Comparing method 154a compares the statistical moments for the queried and the file image sets for each temporal segment by convolution.

The convolution in comparing method 154a convolves the queried and filed one or more of: the first feature mean, the first feature variance, and the first feature skew. In some embodiments, the convolution is weighted, wherein the weighting is a function of chrominance. In some embodiments, the convolution is weighted, wherein the weighting is a function of hue.

The comparing method 154a includes a branching element ending the method flow chart 1900 if the first feature comparing results in no match. Comparing method 154a includes a branching element directing the method flow chart 1900 to a converting method 153b if the first feature comparing method 153a results in a match.

In some embodiments, a match in the first feature comparing method 153a includes one or more of: a distance between queried and file first feature means, a distance between queried and file first feature variances, and a distance between queried and file first feature skews registering a smaller metric than a first feature mean threshold, a first feature variance threshold, and a first feature skew threshold, respectively. The metric for the first feature comparing method 153a can be any of a set of well known distance generating metrics.

The converting method 153b includes extracting a set of nine queried and file wavelet transform coefficients from the queried and file COLOR9 digital image representations. Specifically, the set of nine queried and file wavelet transform coefficients are generated from a grey scale representation of each of the nine color representations includes the COLOR9 digital image representation. In some embodiments, the grey scale representation is approximately equivalent to a corresponding luminance representation of each of the nine color representations includes the COLOR9 digital image representation. In some embodiments, the grey scale representation is generated by a process commonly referred to as color gamut sphering, wherein color gamut sphering approximately eliminates or normalizes brightness and saturation across the nine color representations includes the COLOR9 digital image representation.

In some embodiments, the set of nine wavelet transform coefficients are one of: a set of nine one-dimensional wavelet transform coefficients, a set of one or more non-collinear sets of nine one-dimensional wavelet transform coefficients, and a set of nine two-dimensional wavelet transform coefficients. In some embodiments, the set of nine wavelet transform coefficients are one of: a set of Haar wavelet transform coefficients and a two-dimensional set of Haar wavelet transform coefficients.

The method flow chart 1900 further provides for a comparing method 154b for matching the set of nine queried and file wavelet transform coefficients. In some embodiments, the comparing method 154b includes a correlation function for the set of nine queried and filed wavelet transform coefficients. In some embodiments, the correlation function is weighted, wherein the weighting is a function of hue; that is, the weighting is a function of each of the nine color representations includes the COLOR9 digital image representation.

The comparing method 154b includes a branching element ending the method flow chart 1900 if the comparing method 154b results in no match. The comparing method 154b includes a branching element directing the method flow chart 1900 to an analysis method 155a-156b if the comparing method 154b results in a match.

In some embodiments, the comparing in comparing method 154b includes one or more of: a distance between the set of nine queried and file wavelet coefficients, a distance between a selected set of nine queried and file wavelet coefficients, and a distance between a weighted set of nine queried and file wavelet coefficients.

The analysis method 155a-156b provides for converting the MPEG video image and the file image to one or more queried RGB digital image representation subframes and file RGB digital image representation subframes, respectively, one or more grey scale digital image representation subframes and file grey scale digital image representation subframes, respectively, and one or more RGB digital image representation difference subframes. The analysis method 155a-156b provides for converting directly from the queried and file RGB digital image representations to the associated subframes.

The analysis method 155a-156b provides for the one or more queried and file grey scale digital image representation subframes 155a, including: defining one or more portions of the queried and file RGB digital image representations as one or more queried and file RGB digital image representation subframes, converting the one or more queried and file RGB digital image representation subframes to one or more queried and file grey scale digital image representation subframes, and normalizing the one or more queried and file grey scale digital image representation subframes.

The method for defining includes initially defining identical pixels for each pair of the one or more queried and file RGB digital image representations. The method for converting includes extracting a luminance measure from each pair of the queried and file RGB digital image representation subframes to facilitate the converting. The method of normalizing includes subtracting a mean from each pair of the one or more queried and file grey scale digital image representation subframes.

The analysis method 155a-156b further provides for a comparing method 155b-156b. The comparing method 155b-156b includes a branching element ending the method flow chart 2500 if the second comparing results in no match. The comparing method 155b-156b includes a branching element directing the method flow chart 2500 to a detection analysis method 325 if the second comparing method 155b-156b results in a match.

The comparing method 155b-156b includes: providing a registration between each pair of the one or more queried and file grey scale digital image representation subframes 155b and rendering one or more RGB digital image representation difference subframes and a connected queried RGB digital image representation dilated change subframe 156a-b.

The method for providing a registration between each pair of the one or more queried and file grey scale digital image representation subframes 155b includes: providing a sum of absolute differences (SAD) metric by summing the absolute value of a grey scale pixel difference between each pair of the one or more queried and file grey scale digital image representation subframes, translating and scaling the one or more queried grey scale digital image representation subframes, and repeating to find a minimum SAD for each pair of the one or more queried and file grey scale digital image representation subframes. The scaling for method 155b includes independently scaling the one or more queried grey scale digital image representation subframes to one of: a 128×128 pixel subframe, a 64×64 pixel subframe, and a 32×32 pixel subframe.

The scaling for method 155b includes independently scaling the one or more queried grey scale digital image representation subframes to one of: a 720×480 pixel (480i/p) subframe, a 720×576 pixel (576 i/p) subframe, a 1280×720 pixel (720p) subframe, a 1280×1080 pixel (1080i) subframe, and a 1920×1080 pixel (1080p) subframe, wherein scaling can be made from the RGB representation image or directly from the MPEG image.

The method for rendering one or more RGB digital image representation difference subframes and a connected queried RGB digital image representation dilated change subframe 156a-b includes: aligning the one or more queried and file grey scale digital image representation subframes in accordance with the method for providing a registration 155b, providing one or more RGB digital image representation difference subframes, and providing a connected queried RGB digital image representation dilated change subframe.

The providing the one or more RGB digital image representation difference subframes in method 56a includes: suppressing the edges in the one or more queried and file RGB digital image representation subframes, providing a SAD metric by summing the absolute value of the RGB pixel difference between each pair of the one or more queried and file RGB digital image representation subframes, and defining the one or more RGB digital image representation difference subframes as a set wherein the corresponding SAD is below a threshold.

The suppressing includes: providing an edge map for the one or more queried and file RGB digital image representation subframes and subtracting the edge map for the one or more queried and file RGB digital image representation subframes from the one or more queried and file RGB digital image representation subframes, wherein providing an edge map includes providing a Sobol filter.

The providing the connected queried RGB digital image representation dilated change subframe in method 56a includes: connecting and dilating a set of one or more queried RGB digital image representation subframes that correspond to the set of one or more RGB digital image representation difference subframes.

The method for rendering one or more RGB digital image representation difference subframes and a connected queried RGB digital image representation dilated change subframe 156a-b includes a scaling for method 156a-b independently scaling the one or more queried RGB digital image representation subframes to one of: a 128×128 pixel subframe, a 64×64 pixel subframe, and a 32×32 pixel subframe.

The scaling for method 156a-b includes independently scaling the one or more queried RGB digital image representation subframes to one of: a 720×480 pixel (480 i/p) subframe, a 720×576 pixel (576 i/p) subframe, a 1280×720 pixel (720p) subframe, a 1280×1080 pixel (1080i) subframe, and a 1920×1080 pixel (1080p) subframe, wherein scaling can be made from the RGB representation image or directly from the MPEG image.

The method flow chart 1900 further provides for a detection analysis method 181. The detection analysis method 181 and the associated classify detection method 124 provide video detection match and classification data and images for the display match and video driver 125, as controlled by a user interface. The detection analysis method 181 and the classify detection method 124 further provide detection data to a dynamic thresholds method 182, wherein the dynamic thresholds method 182 provides for one of: automatic reset of dynamic thresholds, manual reset of dynamic thresholds, and combinations thereof.

The method flow chart 1900 further provides a third comparing method 183, providing a branching element ending the method flow chart 1900 if the file database queue is not empty.

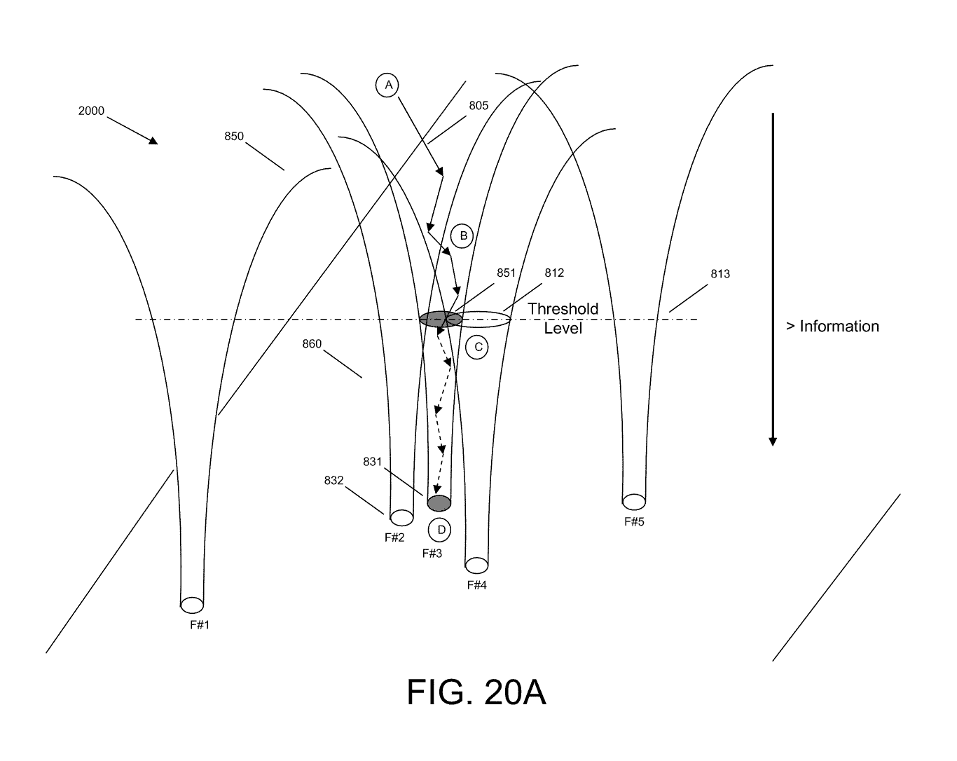

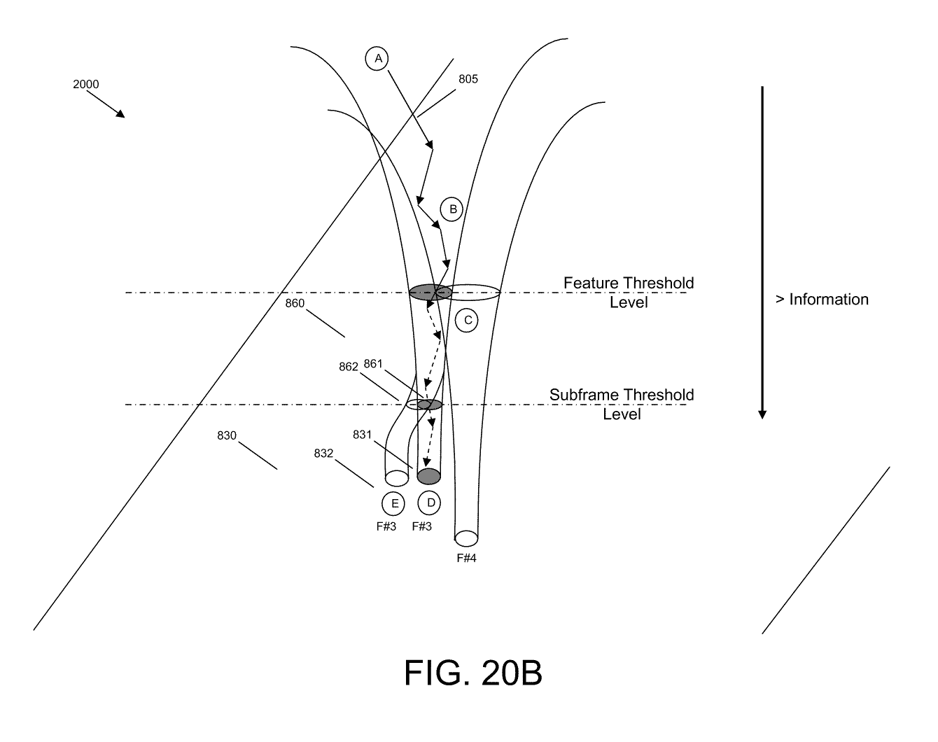

FIG. 20A illustrates an exemplary traversed set of K-NN nested, disjoint feature subspaces in feature space 2000. A queried image 805 starts at A and is funneled to a target file image 831 at D, winnowing file images that fail matching criteria 851 and 852, such as file image 832 at threshold level 813, at a boundary between feature spaces 850 and 860.

FIG. 20B illustrates the exemplary traversed set of K-NN nested, disjoint feature subspaces with a change in a queried image subframe. The a queried image 805 subframe 861 and a target file image 831 subframe 862 do not match at a subframe threshold at a boundary between feature spaces 860 and 830. A match is found with file image 832, and a new subframe 832 is generated and associated with both file image 831 and the queried image 805, wherein both target file image 831 subframe 961 and new subframe 832 comprise a new subspace set for file target image 832.

In some examples, the content analysis server 310 of FIG. 3 is a Web portal. The Web portal implementation allows for flexible, on demand monitoring offered as a service. With need for little more than web access, a web portal implementation allows clients with small reference data volumes to benefit from the advantages of the video detection systems and processes of the present disclosure. Solutions can offer one or more of several programming interfaces using Microsoft .Net Remoting for seamless in-house integration with existing applications. Alternatively or in addition, long-term storage for recorded video data and operative redundancy can be added by installing a secondary controller and secondary signal buffer units.

Fingerprint extraction is described in more detail in International Patent Application Serial No. PCT/US2008/060164, Publication No. WO2008/128143, entitled “Video Detection System And Methods,” incorporated herein by reference in its entirety. Fingerprint comparison is described in more detail in International Patent Application Serial No. PCT/US2009/035617, entitled “Frame Sequence Comparisons in Multimedia Streams,” incorporated herein by reference in its entirety.

The above-described systems and methods can be implemented in digital electronic circuitry, in computer hardware, firmware, and/or software. The implementation can be as a computer program product (i.e., a computer program tangibly embodied in an information carrier). The implementation can, for example, be in a machine-readable storage device, for execution by, or to control the operation of, data processing apparatus. The implementation can, for example, be a programmable processor, a computer, and/or multiple computers.

A computer program can be written in any form of programming language, including compiled and/or interpreted languages, and the computer program can be deployed in any form, including as a stand-alone program or as a subroutine, element, and/or other unit suitable for use in a computing environment. A computer program can be deployed to be executed on one computer or on multiple computers at one site.

Methods and/or portions thereof can be performed by one or more programmable processors executing a computer program to perform functions of the disclosure by operating on input data and generating output. Methods can also be performed by and an apparatus can be implemented as special purpose logic circuitry. The circuitry can, for example, be a FPGA (field programmable gate array) and/or an ASIC (application-specific integrated circuit). Modules, subroutines, and software agents can refer to portions of the computer program, the processor, the special circuitry, software, and/or hardware that implements that functionality.

Processors suitable for the execution of a computer program include, by way of example, both general and special purpose microprocessors, and any one or more processors of any kind of digital computer. Generally, a processor receives instructions and data from a read-only memory or a random access memory or both. The essential elements of a computer are a processor for executing instructions and one or more memory devices for storing instructions and data. Generally, a computer can include, can be operatively coupled to receive data from and/or transfer data to one or more mass storage devices for storing data (e.g., magnetic, magneto-optical disks, or optical disks).

Data transmission and instructions can also occur over a communications network. Information carriers suitable for embodying computer program instructions and data include all forms of non-volatile memory, including by way of example semiconductor memory devices. The information carriers can, for example, be EPROM, EEPROM, flash memory devices, magnetic disks, internal hard disks, removable disks, magneto-optical disks, CD-ROM, and/or DVD-ROM disks. The processor and the memory can be supplemented by, and/or incorporated in special purpose logic circuitry.

To provide for interaction with a user, the above described techniques can be implemented on a computer having a display device. The display device can, for example, be a cathode ray tube (CRT) and/or a liquid crystal display (LCD) monitor. The interaction with a user can, for example, be a display of information to the user and a keyboard and a pointing device (e.g., a mouse or a trackball) by which the user can provide input to the computer (e.g., interact with a user interface element). Other kinds of devices can be used to provide for interaction with a user. Other devices can, for example, be feedback provided to the user in any form of sensory feedback (e.g., visual feedback, auditory feedback, or tactile feedback). Input from the user can, for example, be received in any form, including acoustic, speech, and/or tactile input.

The above described techniques can be implemented in a distributed computing system that includes a back-end component. The back-end component can, for example, be a data server, a middleware component, and/or an application server. The above described techniques can be implemented in a distributing computing system that includes a front-end component. The front-end component can, for example, be a client computer having a graphical user interface, a Web browser through which a user can interact with an example implementation, and/or other graphical user interfaces for a transmitting device. The components of the system can be interconnected by any form or medium of digital data communication (e.g., a communication network). Examples of communication networks include a local area network (LAN), a wide area network (WAN), the Internet, wired networks, and/or wireless networks.

The system can include clients and servers. A client and a server are generally remote from each other and typically interact through a communication network. The relationship of client and server arises by virtue of computer programs running on the respective computers and having a client-server relationship to each other.

Packet-based networks can include, for example, the Internet, a carrier internet protocol (IP) network (e.g., local area network (LAN), wide area network (WAN), campus area network (CAN), metropolitan area network (MAN), home area network (HAN)), a private IP network, an IP private branch exchange (IPBX), a wireless network (e.g., radio access network (RAN), 802.11 network, 802.16 network, general packet radio service (GPRS) network, HiperLAN), and/or other packet-based networks. Circuit-based networks can include, for example, the public switched telephone network (PSTN), a private branch exchange (PBX), a wireless network (e.g., RAN, bluetooth, code-division multiple access (CDMA) network, time division multiple access (TDMA) network, global system for mobile communications (GSM) network), and/or other circuit-based networks.

The display device can include, for example, a computer, a computer with a browser device, a telephone, an IP phone, a mobile device (e.g., cellular phone, personal digital assistant (PDA) device, laptop computer, electronic mail device), and/or other communication devices. The browser device includes, for example, a computer (e.g., desktop computer, laptop computer) with a world wide web browser (e.g., Microsoft® Internet Explorer® available from Microsoft Corporation, Mozilla® Firefox available from Mozilla Corporation). The mobile computing device includes, for example, a personal digital assistant (PDA).

Comprise, include, and/or plural forms of each are open ended and include the listed parts and can include additional parts that are not listed. And/or is open ended and includes one or more of the listed parts and combinations of the listed parts.

While the disclosure has been presented in connection with the specific embodiments, it will be understood that further modification is possible. Furthermore, this application is intended to cover any variations, uses, or adaptations, including such departures from the present disclosure as come within known or customary practice in the art to which the disclosure pertains, and as fall within the scope of the appended claims.

All publications, patents, and patent applications mentioned in this specification are herein incorporated by reference to the same extent as if each individual publication, patent, or patent application was specifically and individually indicated to be incorporated by reference.

What is claimed is:

1. A method for supplemental media delivery, the method comprising:
generating a first descriptor based on first media data, the first media data associated with a first subscriber computing device;
comparing the first descriptor and a second descriptor;
determining second media data based on the comparison of the first descriptor and the second descriptor; and
transmitting the second media data to a second subscriber computing device.

2. The method of claim 1, wherein the first media data comprises a video and the second media data comprises an advertisement associated with the video.

3. The method of claim 1, wherein the first media data comprises a first video and the second media data comprises a second video, wherein the first video is associated with the second video.

4. The method of claim 1, further comprising determining the second media data based on an identity of the first media data.

5. The method of claim 4, further comprising determining the identity of the first media data based on the first descriptor and a plurality of identities stored in a storage device.

6. The method of claim 1, further comprising determining the second media data based on an association between the first media data and the second media data.

7. The method of claim 6, further comprising determining the association between the first media data and the second media data from a plurality of associations of media data stored in a storage device.

8. The method of claim 1, further comprising:
transmitting a request for the first media data to a content provider, the request comprising information associated with the first subscriber computing device; and
receiving the first media data from the content provider.

9. The method of claim 1, further comprising:
identifying a first network transmission path associated with the first subscriber computing device; and
intercepting the first media data during transmission to the first subscriber computing device via the first network transmission path.

10. The method of claim 1, further comprising:
determining a selectable link from a plurality of selectable links based on the second media data;
transmitting the selectable link to the second subscriber computing device.

11. The method of claim 1, wherein the first subscriber computing device and the second subscriber computing device are associated with a first subscriber.

12. The method of claim 1, wherein the first subscriber computing device and the second subscriber computing device are in a same geographic location.

13. The method of claim 1, wherein the second media data comprises all or part of the first media data.

14. The method of claim 1, wherein the second descriptor is similar to part or all of the first descriptor.

15. The method of claim 1, wherein the first media data comprises video.

16. The method of claim 1, wherein the first media data comprises video, audio, text, an image, or any combination thereof.

17. The method of claim 1, wherein the second media data is associated with the first media data.

18. The method of claim 1, wherein the comparison of the first descriptor and the second descriptor is indicative of an association between the first media data and the second media data.

19. A method for supplemental media delivery, the method comprising:
receiving a first descriptor from a first subscriber computing device, the first descriptor being generated based on first media data;
comparing the first descriptor and a second descriptor;
determining second media data based on the comparison of the first descriptor and the second descriptor; and
transmitting the second media data to a second subscriber computing device.

20. A computer program product comprising a non-transitory machine-readable medium having instructions stored thereon, the instructions being executable by a data processing apparatus to:
generate a first descriptor based on first media data, the first media data being associated with a first subscriber computing device;
compare the first descriptor and a second descriptor;
determine second media data based on the comparison of the first descriptor and the second descriptor; and
transmit the second media data to a second subscriber computing device.

21. A system for supplemental media delivery, the system comprising:
a media fingerprint module configured to generate a first descriptor based on first media data, the first media data being associated with a first subscriber computing device;
a media fingerprint comparison module configured to compare the first descriptor and a second descriptor and determine second media data based on the comparison of the first descriptor and the second descriptor; and
a communication module configured to transmit the second media data to a second subscriber computing device.

22. The system of claim 21, wherein the first media data comprises a video and the second media data comprises an advertisement associated with the video.

23. The system of claim 21, wherein the first media data comprises a first video and the second media data comprises a second video, the first video is associated with the second video.

24. The system of claim 21, wherein the media fingerprint comparison module is further configured to determine the second media data based on an identity of the first media data.

25. The system of claim 24, wherein the media fingerprint comparison module is further configured to determine the identity of the first media data based on the first descriptor and a plurality of identities stored in a storage device.

26. The system of claim 21, wherein the media fingerprint comparison module is further configured to determine the second media data based on an association between the first media data and the second media data.

27. The system of claim 26, wherein the media fingerprint comparison module is further configured to determine the association between the first media data and the second media data from a plurality of associations of media data stored in a storage device.

28. The system of claim 21, wherein the communication module is further configured to transmit a request for the first media data to a content provider, the request comprising information associated with the first subscriber computing device, wherein the communication module is further configured to receive the first media data from the content provider.

29. The system of claim 21, wherein the communication module is further configured to identify a first network transmission path associated with the first subscriber computing device and intercept the first media data during transmission to the first subscriber computing device via the first network transmission path.

30. The system of claim 21, further comprising:
a link module configured to determine a selectable link from a plurality of selectable links based on the second media data;
wherein the communication module is further configured to transmit the selectable link to the second subscriber computing device.

31. The system of claim 21, wherein the first subscriber computing device and the second subscriber computing device are associated with a first subscriber.

32. The system of claim 21, wherein the first subscriber computing device and the second subscriber computing device are in a same geographic location.

33. The system of claim 21, wherein the second media data comprises all or part of the first media data.

34. The system of claim 21, wherein the second descriptor is similar to part or all of the first descriptor.

35. The system of claim 21, wherein the first media data comprises video.

36. The system of claim 21, wherein the first media data comprises video, audio, text, an image, or any combination thereof.

37. The system of claim 21, wherein the second media data is associated with the first media data.

38. The system of claim 21, wherein the comparison of the first descriptor and the second descriptor is indicative of an association between the first media data and the second media data.

39. A system for supplemental media delivery, the system comprising:
a communication module implemented in instructions stored on a non-transitory machine readable medium, the instructions being executable by a processor to implement the communication module, the communication module being configured to:
receive a first descriptor from a first subscriber computing device, the first descriptor being generated based on first media data, and
transmit second media data to a second subscriber computing device; and
a media fingerprint comparison module implemented in instructions stored on a non-transitory machine readable medium, the instructions being executable by a processor to implement the media fingerprint comparison module, the media fingerprint comparison module being configured to:
compare the first descriptor and the second descriptor, and
determine the second media data based on the comparison of the first descriptor and the second descriptor.
